(19) United States
(12) Patent Application Publication
(10) Pub. No.: US 2012/0297009 A1
(43) Pub. Date: Nov. 22, 2012

(54) METHOD AND SYSTEM FOR CAHING IN MOBILE RAN

(75) Inventors: Ofir AMIR, Binyamina (IL); Or AMIZUR, Rosh HaAyin (IL); Ohad DEKEL, Kiryat Ono (IL); Arik Eizikovich, Rishon Le-Zion (IL)

(73) Assignee: OVERSI NETWORKS LTD., Petach Tikva (IL)

(21) Appl. No.: 13/409,125

(22) Filed: Mar. 1, 2012

Related U.S. Application Data
(60) Provisional application No. 61/487,297, filed on May 18, 2011.

(51) Int. Cl. G06F 15/167

(52) U.S. Cl. 709/213

(57) ABSTRACT

A non-transitory computer readable medium and a method that may include receiving, at a first level cache that is coupled to a radio access network (RAN) component, a data entity that comprises an address; wherein each cache of the hierarchical group of caches is coupled to a component of the RAN or to a component of a core network that is coupled between the RAN and the Internet; identifying the data entity as comprising a request to receive information from a requesting entity that is wirelessly coupled to the RAN—if the address belongs to a root cache address range; providing the information, by the first level cache, to the requesting entity if the content is stored in the first level cache; and sending to an intermediate level cache the data entity if the information is not stored in the first level cache.

### RELATED APPLICATIONS

This patent application claims priority from U.S. provisional patent application filing date May 18, 2011, Ser. No. 61/487297, which is incorporated herein in its entirety.

### BACKGROUND OF THE INVENTION

Cellular operators are competing traditional broadband operators by offering mobile broadband access and IP services such as rich multimedia to laptops and other advanced handsets. They offer these services through access networks such as High-Speed Packet Access (HSPA), Evolution-Data Optimized (EV-DO) and, in the near future, Long-Term Evolution (LTE). These access networks promise to deliver performance comparable to today's ADSL services, but with the added benefit of mobility and ubiquitous coverage. However, enormous capacity upgrade is required to new technologies to satisfy the high bandwidth demand. This upgrade is expected to be extremely expensive and its cost casts a real doubt on the profitability of enhanced network deployment. As a result, cellular operators are seeking for data reduction solutions integrated with their network upgrades.

### SUMMARY

According to an embodiment of the invention a system may be provided and may include a hierarchical group of caches that may include a root cache that may be located at a Core IP network (a network that may be coupled between the RAN and the Internet), the Core Ip network can be accessed from all the RAN. The hierarchical group of caches may also include at least one first level cache and zero or more intermediate level caches. Each cache of the first or intermediate levels may be coupled to a component of the RAN. Each cache may be located in any location of the RAN hierarchy covering the RAN fully or partially. The root cache can be an out of band root cache as it does not receive the transferred information or content but receives the requests to receive the content and any control signals that may assist in the caching of content, and or transferring the content.

According to an embodiment of the invention a method may be provided and may include receiving by the root cache redirector (that is out of band) a data entity that comprises an address; identifying the data entity as may include a request to receive information from a requesting entity that is wirelessly coupled to the RAN; identifying the requested information and determine if it is cached by one of caches; redirecting the request to an address that belongs to a root cache address range; identifying the request to the root cache address ranges by the first level cache; providing the requested information, by the first level cache, to the requesting entity if the content is stored in the first level cache.

The method may include passing the data entity containing the request for information by the first level cache if it is not cached by the first level cache to a higher level of the RAN network; identifying the request to the root cache address ranges by an intermediate level cache; providing the requested information by the intermediate level, to the requesting entity if the content is stored in the intermediate level cache;

The method may include passing the data entity containing the request for information by the receiving cache which is part of the RAN if it is not cached by the cache to a higher level of the RAN network;

The method may include receiving data entity containing the request for information sent to the root cache address ranges, by the root cache and providing the requested information, by the root cache to the requesting entity as the content is always stored by the root cache.

The identifying may be executed without performing deep packet probing, but by only inspecting the destination address of the requests and identifying the address ranges of the root cache.

The method may include intercepting handover information indicative of an expected handover of the requesting entity from a first site of the RAN to a second site of the RAN. The expected handover is expected to occur before an information portion is to be provided to the requesting entity. The first site is serviced by one cache and the second site is serviced by another cache of the hierarchical group of caches. The method may proceed by sending from the first level cache to other cache metadata indicative of the information portion; and providing the information portion to the requesting entity by the other cache after an occurrence of the handover.

According to an embodiment of the invention a method may be provided and may include: (a) intercepting handover information indicative of an already performed handover of the requesting entity from a first site of the RAN to a second site of the RAN; wherein the handover has occurred before an information portion is to be provided to the requesting entity; wherein the first site is serviced by one cache and the second site is serviced by another cache of the hierarchical group of caches; wherein information sent from the first cache is being forwarded to the requesting entity in its new location by the RAN itself; (b) Identifying the handover indication by the second cache; (c) sending a request from the second cache to the first cache for the cache metadata indicative of the information portion; (d) and providing the information portion to the requesting entity by the second cache after receiving the metadata indicative of the information portion.

The method may include forwarding by the first or intermediate level cache to the root cache, data entities received from the requesting client and containing acknowledges on the receive of data entities sent by the first or intermediate level cache to the requesting entity.

The method may include (a) using such acknowledges received by the root cache to monitor the delivery progress of the requested information to update a separated billing entity on the requesting entity data usage, and (b) receiving from the billing entities allowance of data quantities assigned to this user; wherein the billing entity may be operated by the cellular operator for management of pre-paid users.

The method may include sending by the root cache a data entity to the requesting entity, wherein this data entity contains reset command to the data session; when the user data usage reach its allowance of data quantity as set by the billing entity.

According to an embodiment of the invention a method may be provided and may include sending from the first or intermediate level cache to the root cache metadata indicative of the information portion when the first or intermediate level cache starts to provide the information portion to a requesting entity; storing the metadata indicative of the information portion; using the metadata indicative of the information portion to intercept handovers which were not detected by the RAN messages, or for detecting RAN caches failures.

The method may include detecting a failure or unexpected handover by the root cache; using the metadata indicative of the information portion by the root cache to intercepts handovers or failed sessions and continue serving seamlessly.

The method may include detecting a failure or unexpected handover by one of the other first or intermediate level cache; sending a request for metadata indicative of the information portion from the other first or intermediate level cache to the root cache; receiving a response with the metadata indicative of the information portion from the root cache by the other first or intermediate level cache; using the metadata indicative of the information portion by other first or intermediate level cache to intercepts handovers or failed session to seamlessly continue serving.

The method may include detecting a handover from an uncovered RAN segment to a segment covered by one of the first or intermediate level cache, by identifying a new session not handled with the address of the root cache; sending a request for metadata indicative of the information portion from the other first or intermediate level cache to the root cache; receiving a response with the metadata indicative of the information portion from the root cache by the other first or intermediate level cache; using the metadata indicative of the information portion by other first or intermediate level cache to intercepts handovers to seamlessly continue serving.

According to an embodiment of the invention a method may be provided and may include adding, by the redirector, quality of service information related to a quality of service to be associated with a response to a redirected request; receiving, by any first or intermediate level cache the quality of service information, and acting upon it while serving the requested information, e.g. by using a specific bit rate or applying any other QoS property on the delivery.

The method may include adding, by the redirector, any additional information to the redirected request; the first or intermediate level cache receiving the additional information, and changing their delivery behavior according to it.

According to an embodiment of the invention a method may be provided and may include: receiving, at a first level cache that is coupled to a radio access network (RAN) component, a data entity that may include an address; wherein the first level cache belongs to a hierarchical group of caches that may include a root cache, at least zero intermediate level caches and at least one first level cache; wherein each cache of the hierarchical group of caches is coupled to a component of the RAN or to a component of a core network that is coupled between the RAN and the Internet; identifying the data entity as may include a request to receive information from a requesting entity that is wirelessly coupled to the RAN—if the address belongs to a root cache address range; providing the information, by the first level cache, to the requesting entity if the content is stored in the first level cache; and sending to an intermediate level cache the data entity if the information is not stored in the first level cache.

Each cache of the first level or any intermediate level may be coupled to a component of the RAN. Each cache may be located in any location of the RAN hierarchy covering the RAN fully or partially.

The root cache can be an out of band root cache as it does not receive the transferred information or content but receives the requests to receive the content and any control signals that may assist in the caching of content, and or transferring the content.

The method may include receiving, by an intermediate level cache, the data entity; providing the information, by the intermediate level cache, to the requesting entity if the information is stored in the intermediate level cache; and sending to a higher level cache the data entity if the information is not stored in the intermediate level cache.

The identifying may be executed without performing deep packet probing.

The method may include: intercepting handover information indicative of an expected handover of the requesting entity from a first site of the RAN to a second site of the RAN; wherein the expected handover is expected to occur before an information portion is to be provided to the requesting entity; wherein the first site is serviced by the first level cache and the second site is serviced by another cache of the hierarchical group of caches; sending from the first level cache to other cache metadata indicative of the information portion; and providing the information portion to the requesting entity by the other cache after an occurrence of the handover.

The method may include terminating by the first level cache a connection between the requesting entity and the first level cache in proximity to the handover.

The method according to claim 4, may include determining to terminate a connection between the requesting entity and the first level cache in proximity to the handover in response to a size of the information portion; and terminating the connection in proximity to the handover if it is determined to terminate the connection.

The method may include receiving another request from the requesting entity to obtain additional information, while the first level cache provides previously requested information over a currently established connection between the requesting entity and the first level cache; and determining, by the first level cache, whether to provide the additional information over the previously established connection in response to at least one parameter out of (a) a size of the previously requested information, (b) a size of portion of the previously requested information that was not yet provided to the requesting entity; (c) a size of portion of the previously requested information that was already provided to the requesting entity; (d) a size of the additional information.

The method may include receiving another request from the requesting entity to obtain additional information, while the first level cache provides previously requested information over a currently established connection between the requesting entity and the first level cache; and determining, by the first level cache, whether to provide the additional information over the previously established connection in response to a size of the additional information and at least one size attribute related to the previously requested information.

The method may include receiving another request from the requesting entity to obtain additional information, while the first level cache provides previously requested information over a currently established connection between the requesting entity and the first level cache; and determining, by the first level cache, whether to provide the additional information over another connection in response to at least one out of a size of the additional information and at least one size attribute related to the previously requested information.

The method may include receiving another request from the requesting entity to obtain additional information, while the first level cache provides previously requested information over a currently established connection between the requesting entity and the first level cache; and determining, by the first level cache, whether to provide the additional information over another connection or over the previously established connection in response to a number of information requests that are serviced over the previously established connection.

The method may include receiving another request from the requesting entity to obtain additional information, while the first level cache provides previously requested information over a currently established connection between the requesting entity and the first level cache; and determining, by the first level cache, whether to provide the additional information by the first level cache or a higher level cache of the hierarchical group of caches in response to a characteristic of one or more information requests that are serviced by the first level cache.

The method may include: intercepting handover information indicative of an expected handover of the requesting entity from a first site of the RAN to a second site of the RAN; wherein the expected handover is expected to occur before an information portion is to be provided to the requesting entity; wherein requests for information generated after the handover at the first site are serviced by the first level cache and requests for information generated after the handover at the second site is serviced by another cache of the hierarchical group of caches; and providing the information portion to the first site by the first level cache to be later transmitted from the first site to the second site.

The method may be at least partially executed by a root cache that may cache all information stored in any other caches of the hierarchical group of caches.

According to an embodiment of the invention a method may be provided and may include intercepting, by a redirector, a request from a requesting entity that is coupled to a radio access network (RAN), to receive information from an information source that is coupled to the Internet or belongs to the Internet; determining, by the redirector, whether the information should be provided from the information source or from a cache of a hierarchical group of caches that may include a root cache, at least zero intermediate level caches and at least one first level cache; if it is determined to provide the information from the cache then associating with the information an address out of a root cache address range, the address is indicative that the information is to be provided by a cache of the hierarchical group of caches.

The method may include: receiving from the requesting entity a data entity that may include a request to receive the information, the request may include the address out of the root cache address range; identifying the data entity as may include the request to receive the information in response to the address; and providing the information, by a cache of the hierarchical group of caches.

The method may include receiving by the root cache the data entity; and providing by the root cache the information.

The method may include pushing, by the root cache, information stored in the root cache to other caches of the hierarchical group of caches.

The method may include pushing, by the root cache, information stored in the root cache to other caches of the hierarchical group of caches; wherein the pushing is responsive to a status of the RAN.

The method may include determining, the redirector, that the information should be provided from the information source and not from any cache of the hierarchical group of caches if the requesting entity is tagged as a requesting entity for which information exchange should be recorded.

The method may include determining, the redirector, that the information should be provided from the root cache if the requesting entity is tagged as a requesting entity for which information exchange should be recorded; wherein if it is determined that the information should be provided from the root cache than assigning to the information an address out of a dedicated address range allocated for information that is to be provided to requesting entities that are tagged as requesting entities for which information exchange should be recorded; wherein the dedicated address range differs from the root cache address range.

Any request for information from a requesting entity that is tagged as a requesting entity for which information exchange should be recorded may be serviced by the root cache and not by any other member of the hierarchical group of caches.

According to an embodiment of the invention a non-transitory computer readable medium may be provided and may store instructions for: receiving, at a first level cache that is coupled to a radio access network (RAN) component, a data entity that may include an address; wherein the first level cache belongs to a hierarchical group of caches that may include a root cache, at least zero intermediate level caches and at least one first level cache; wherein each cache of the hierarchical group of caches is coupled to a component of the RAN or to a component of a core network that is coupled between the RAN and the Internet; identifying the data entity as that may be arranged to store instructions for a request to receive information from a requesting entity that is wirelessly coupled to the RAN—if the address belongs to a root cache address range; providing the information to the requesting entity if the content is stored in the first level cache; and sending to an intermediate level cache the data entity if the information is not stored in the first level cache.

The non-transitory computer readable medium may be arranged to store instructions for: receiving, by an intermediate level cache, the data entity; providing the information, by the intermediate level cache, to the requesting entity if the information is stored in the intermediate level cache; and sending to a higher level cache the data entity if the information is not stored in the intermediate level cache.

The non-transitory computer readable medium may be arranged to store instructions for identifying without performing deep packet probing.

The non-transitory computer readable medium may be arranged to store instructions for: intercepting handover information indicative of an expected handover of the requesting entity from a first site of the RAN to a second site of the RAN; wherein the expected handover is expected to occur before an information portion is to be provided to the requesting entity; wherein the first site is serviced by the first level cache and the second site is serviced by another cache of the hierarchical group of caches; sending from the first level cache to other cache metadata indicative of the information portion; and providing the information portion to the requesting entity by the other cache after an occurrence of the handover.

The non-transitory computer readable medium may be arranged to store instructions for terminating by the first level cache a connection between the requesting entity and the first level cache in proximity to the handover.

The non-transitory computer readable medium may be arranged to store instructions for determining to terminate a connection between the requesting entity and the first level cache in proximity to the handover in response to a size of the information portion; and terminating the connection in proximity to the handover if it is determined to terminate the connection.

The non-transitory computer readable medium may be arranged to store instructions for receiving another request from the requesting entity to obtain additional information, while the first level cache provides previously requested information over a currently established connection between the requesting entity and the first level cache; and determining, by the first level cache, whether to provide the additional information over the previously established connection in response to at least one parameter out of (a) a size of the previously requested information, (b) a size of portion of the previously requested information that was not yet provided to the requesting entity; (c) a size of portion of the previously requested information that was already provided to the requesting entity; (d) a size of the additional information.

The non-transitory computer readable medium may be arranged to store instructions for receiving another request from the requesting entity to obtain additional information, while the first level cache provides previously requested information over a currently established connection between the requesting entity and the first level cache; and determining, by the first level cache, whether to provide the additional information over the previously established connection in response to a size of the additional information and at least one size attribute related to the previously requested information.

The non-transitory computer readable medium may be arranged to store instructions for receiving another request from the requesting entity to obtain additional information, while the first level cache provides previously requested information over a currently established connection between the requesting entity and the first level cache; and determining, by the first level cache, whether to provide the additional information over another connection in response to at least one out of a size of the additional information and at least one size attribute related to the previously requested information.

The non-transitory computer readable medium may be arranged to store instructions for receiving another request from the requesting entity to obtain additional information, while the first level cache provides previously requested information over a currently established connection between the requesting entity and the first level cache; and determining, by the first level cache, whether to provide the additional information over another connection or over the previously established connection in response to a number of information requests that are serviced over the previously established connection.

The non-transitory computer readable medium may be arranged to store instructions for receiving another request from the requesting entity to obtain additional information, while the first level cache provides previously requested information over a currently established connection between the requesting entity and the first level cache; and determining, by the first level cache, whether to provide the additional information by the first level cache or a higher level cache of the hierarchical group of caches in response to a characteristic of one or more information requests that are serviced by the first level cache.

The non-transitory computer readable medium may be arranged to store instructions for: intercepting handover information indicative of an expected handover of the requesting entity from a first site of the RAN to a second site of the RAN; wherein the expected handover is expected to occur before an information portion is to be provided to the requesting entity; wherein requests for information generated after the handover at the first site are serviced by the first level cache and requests for information generated after the handover at the second site is serviced by another cache of the hierarchical group of caches; and providing the information portion to the first site by the first level cache to be later transmitted from the first site to the second site.

The non-transitory computer readable medium may be arranged to store instructions for storing at the root cache caches all information stored in any other caches of the hierarchical group of caches.

According to an embodiment of the invention a non-transitory computer readable medium may be provided and may be arranged to store instructions for: intercepting a request from a requesting entity that is coupled to a radio access network (RAN), to receive information from an information source that is coupled to the Internet or belongs to the Internet; determining whether the information should be provided from the information source or from a cache of a hierarchical group of caches that may include a root cache, at least zero intermediate level caches and at least one first level cache; if it is determined to provide the information from the cache then associating with the information an address out of a root cache address range, the address is indicative that the information is to be provided by a cache of the hierarchical group of caches.

The non-transitory computer readable medium may be arranged to store instructions for: receiving from the requesting entity a data entity that may include a request to receive the information, the request may include the address out of the root cache address range; identifying the data entity as that may be arranged to store instructions for the request to receive the information in response to the address; and providing the information, by a cache of the hierarchical group of caches.

The non-transitory computer readable medium may be arranged to store instructions for receiving by the root cache the data entity; and providing by the root cache the information.

The non-transitory computer readable medium may be arranged to store instructions for pushing, by the root cache, information stored in the root cache to other caches of the hierarchical group of caches.

The non-transitory computer readable medium may be arranged to store instructions for pushing, by the root cache, information stored in the root cache to other caches of the hierarchical group of caches; wherein the pushing is responsive to a status of the RAN.

The non-transitory computer readable medium may be arranged to store instructions for determining, the redirector, that the information should be provided from the information source and not from any cache of the hierarchical group of caches if the requesting entity is tagged as a requesting entity for which information exchange should be recorded.

The non-transitory computer readable medium may be arranged to store instructions for determining, the redirector, that the information should be provided from the root cache if the requesting entity is tagged as a requesting entity for which information exchange should be recorded; wherein if it is determined that the information should be provided from the root cache than assigning to the information an address out of a dedicated address range allocated for information that is to be provided to requesting entities that are tagged as requesting entities for which information exchange should be recorded; wherein the dedicated address range differs from the root cache address range.

Any request for information from a requesting entity that is tagged as a requesting entity for which information exchange should be recorded is serviced by the root cache and not by any other member of the hierarchical group of caches.

According to an embodiment of the invention a system may be provided and may include a hierarchical group of caches that may include a root cache, at least zero intermediate level caches and at least one first level cache; wherein each cache of the hierarchical group of caches is coupled to a component of the RAN or to a component of a core network that is coupled between the RAN and the Internet. Wherein each cache of the hierarchical group of caches is arranged to receive a data entity that may include an address; to provide the information, by the cache, to the requesting entity if the content is stored in the cache; and send to a cache of a higher level (than the level of the cache) the data entity if the information is not stored in the cache.

A first level cache can be arranged to receive the data entity; to provide the information, by the first level cache, to the requesting entity if the content is stored in the first level cache; and send to an intermediate cache or to the root cache the data entity if the information is not stored in the first level cache.

An intermediate level cache can be arranged to provide the information to the requesting entity if the information is stored in the intermediate level cache; and to send to a higher level cache the data entity if the information is not stored in the intermediate level cache.

Each cache can execute the identifying without performing deep packet probing.

The first level cache may be arranged to intercept handover information indicative of an expected handover of the requesting entity from a first site of the RAN to a second site of the RAN; wherein the expected handover is expected to occur before an information portion is to be provided to the requesting entity; wherein the first site is serviced by the first level cache and the second site is serviced by another cache of the hierarchical group of caches; to send from the first level cache to other cache metadata indicative of the information portion; and provide the information portion to the requesting entity by the other cache after an occurrence of the handover. The interception and sending of the information can be executed by an intermediate level cache or by the root cache.

The first level cache may terminate a connection between the requesting entity and the first level cache in proximity to the handover.

The first level cache can be arranged to determining to terminate a connection between the requesting entity and the first level cache in proximity to the handover in response to a size of the information portion; and terminating the connection in proximity to the handover if it is determined to terminate the connection.

The first level cache may be arranged to receive another request from the requesting entity to obtain additional information, while the first level cache provides previously requested information over a currently established connection between the requesting entity and the first level cache; and determine, whether to provide the additional information over the previously established connection in response to at least one parameter out of (a) a size of the previously requested information, (b) a size of portion of the previously requested information that was not yet provided to the requesting entity; (c) a size of portion of the previously requested information that was already provided to the requesting entity; (d) a size of the additional information.

The first level cache may be arranged to receive another request from the requesting entity to obtain additional information, while the first level cache provides previously requested information over a currently established connection between the requesting entity and the first level cache; and determine, whether to provide the additional information over the previously established connection in response to a size of the additional information and at least one size attribute related to the previously requested information.

The first level cache may be arranged to receive another request from the requesting entity to obtain additional information, while the first level cache provides previously requested information over a currently established connection between the requesting entity and the first level cache; and determine, whether to provide the additional information over another connection in response to at least one out of a size of the additional information and at least one size attribute related to the previously requested information.

The first level cache may be arranged to receive another request from the requesting entity to obtain additional information, while the first level cache provides previously requested information over a currently established connection between the requesting entity and the first level cache; and determine, whether to provide the additional information over another connection or over the previously established connection in response to a number of information requests that are serviced over the previously established connection.

The first level cache may be arranged to receive another request from the requesting entity to obtain additional information, while the first level cache provides previously requested information over a currently established connection between the requesting entity and the first level cache; and determine, whether to provide the additional information by the first level cache or a higher level cache of the hierarchical group of caches in response to a characteristic of one or more information requests that are serviced by the first level cache.

The first level cache may be arranged to intercept handover information indicative of an expected handover of the requesting entity from a first site of the RAN to a second site of the RAN; wherein the expected handover is expected to occur before an information portion is to be provided to the requesting entity; wherein requests for information generated after the handover at the first site are serviced by the first level cache and requests for information generated after the handover at the second site is serviced by another cache of the hierarchical group of caches; and provide the information portion to the first site by the first level cache to be later transmitted from the first site to the second site.

The root cache that may cache all information stored in any other caches of the hierarchical group of caches.

According to an embodiment of the invention a system may be provided and may include a redirector and a hierarchical group of caches that may include a root cache, at least zero intermediate level caches and at least one first level cache. The redirector may be arranged to intercept a request from a requesting entity that is coupled to a radio access network (RAN), to receive information from an information source that is coupled to the Internet or belongs to the Internet and to determine, by the redirector, whether the information should be provided from the information source or from a cache of the hierarchical group of caches. If it is determined to provide the information from the cache then the redirector or the root cache may be arranged to associate with the information an address out of a root cache address range, the address is indicative that the information is to be provided by a cache of the hierarchical group of caches.

Any cache of the hierarchical group of caches may be arranged to receive from the requesting entity a data entity that may include a request to receive the information, the request may include the address out of the root cache address range; identify the data entity as may include the request to receive the information in response to the address; and provide the information, by the cache the received the data entity or by another cache of the hierarchical group of caches.

The root cache may be arranged to receive the data entity and provide the information.

The root cache may be arranged to push information stored in the root cache to other caches of the hierarchical group of caches. The pushing may be responsive to a status of the RAN.

The redirector may be arranged to determine that the information should be provided from the information source and not from any cache of the hierarchical group of caches if the requesting entity is tagged as a requesting entity for which information exchange should be recorded.

The redirector may be arranged to determine that the information should be provided from the root cache if the requesting entity is tagged as a requesting entity for which information exchange should be recorded. If it is determined that the information should be provided from the root cache than the root cache or the redirector may assign to the information an address out of a dedicated address range allocated for information that is to be provided to requesting entities that are tagged as requesting entities for which information exchange should be recorded; wherein the dedicated address range differs from the root cache address range.

The root cache may be arranged to service any request for information from a requesting entity that is tagged as a requesting entity for which information exchange, while other caches of the hierarchical group of caches can be prevented from servicing such a request.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 illustrates Locations for local caches in a 4G 3GPP's RANs (Radio Access Networks) according to an embodiment of the invention;

FIG. 2 illustrates High-level description of the local cache system according to an embodiment of the invention;

FIG. 3 illustrates Mobile cache system components according to an embodiment of the invention;

FIG. 4 illustrates a timing diagram according to an embodiment of the invention;

FIG. 5 illustrates Object Push operation according to an embodiment of the invention;

FIG. 6 illustrates high level message flow between the cache system component-basic scenario (local cache hit) according to an embodiment of the invention;

FIG. 7 illustrates high level message flow between the cache system component-Root cache hit according to an embodiment of the invention;

FIG. 8 illustrates high level message flow between the cache system component-Cache miss according to an embodiment of the invention;

FIG. 9 illustrates high level message flow between the cache system component-basic scenario (local cache hit) according to an embodiment of the invention;

FIG. 10 illustrates high level message flow between the cache system component-Root cache hit according to an embodiment of the invention;

FIG. 11 illustrates high level message flow between the cache system component transparent web-proxy-Cache miss according to an embodiment of the invention

FIG. 12 illustrates Intra-LTE (Intra-MME/SGW) Handover Using the X2 Interface according to an embodiment of the invention;

FIG. 13 illustrates Intra-LTE (Intra-MME/SGW) Handover Using the S1 Interface according to an embodiment of the invention;

FIG. 14 illustrates Inter-MME Handover (Intra-SGW) according to an embodiment of the invention;

FIG. 15 illustrates Inter-MME/SGW Handover according to an embodiment of the invention;

FIG. 16 illustrates TCP handover from local cache to local cache (HSPA) according to an embodiment of the invention;

FIG. 17 illustrates TCP handover between local cache and Root cache (HSPA) according to an embodiment of the invention;

FIG. 18 illustrates Cache Locations within the Mobile network according to an embodiment of the invention;

FIG. 19 illustrates LTE Handover using the Si Interface cache flow according to an embodiment of the invention;

FIG. 20 illustrates Intra-LTE (Intra-MME/SGW) Handover Using the X2 Interface cache flow according to an embodiment of the invention;

FIGS. 21-23 illustrate a method according to an embodiment of the invention; and

FIG. 24 illustrates a method according to an embodiment of the invention;

FIG. 25 illustrates a method according to an embodiment of the invention;

FIG. 26 illustrates a method according to an embodiment of the invention; and

FIG. 27 illustrates a method according to an embodiment of the invention.

### DETAILED DESCRIPTION OF THE DRAWINGS

The foregoing and other objects, features, and advantages of the present invention will become more apparent from the following detailed description when taken in conjunction with the accompanying drawings. In the drawings, similar reference characters denote similar elements throughout the different views.

Because the illustrated embodiments of the present invention may for the most part, be implemented using electronic components and circuits known to those skilled in the art, details will not be explained in any greater extent than that considered necessary for the understanding and appreciation of the underlying concepts of the present invention and in order not to obfuscate or distract from the teachings of the present invention.

Any reference to a method may be interpreted to a reference to a system executing the method and, additionally or alternatively to a non-transitory computer readable medium capable of storing instructions that once executed result in the execution of the method. Any combination of any of originally filed claims 1-27 can be provided. A system can be provided that may execute any combination of originally filed claims 1-27. A non-transitory computer readable medium can be provided that stores any combination of instructions out of those illustrated in originally filed claims 28-52.

Any cache, redirector has a hardware component.

The term local cache can include a first level cache or an intermediate level cache. A first level cache is a cache that is positioned at the closest position to user devices. An intermediate level cache is positioned between a root cache and a RAN components that may be coupled to a first level cache. Any action executed by a first level cache can be executed by an intermediate level cache.

There may be provided a system that provides a caching solution. The system provides a cache solution (web cache, streaming cache and P2P cache) at the cellular RAN.

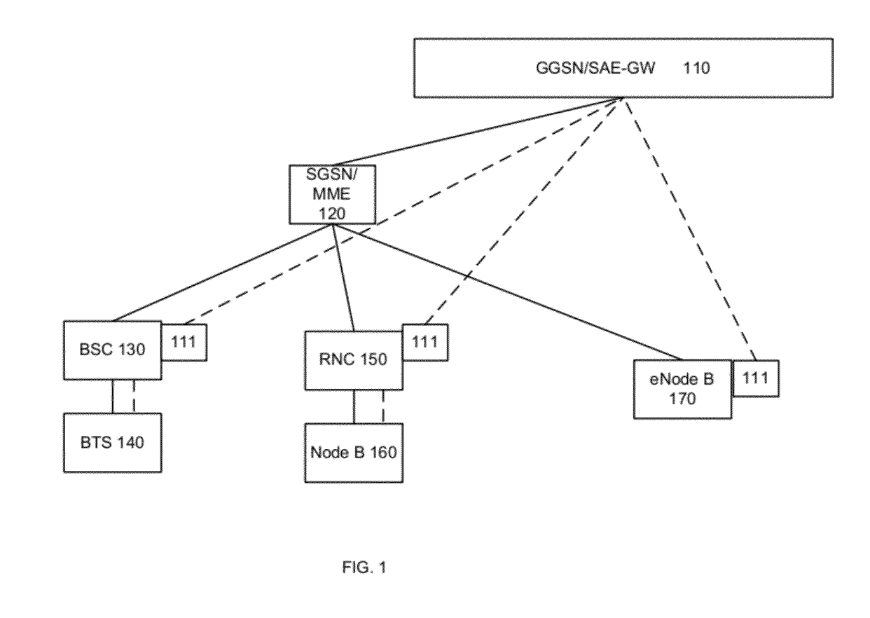

As plotted in FIG. 1, regarding HSPA networks, the system (including a hierarchical group of caches 111) may be located at the RNC 150 (at the Iu-PS interface). Regarding LTE networks, the system can be implemented at the eNode-B 170 (at the Si interface) or at a combination of eNode-B and aggregation points. FIG. 1 also illustrates GGSN/SAE-GW 110, SGSN/MME 120, BSC 130, BTS 140 and Node B 160. Dashed lines illustrate control plane while full lines illustrate data plane.

Assuming a user UE is moving from location a to location b, (either, a SRNS relocation procedure is performed in HSPA, or, one of the above-mentioned handovers in LTE), there are four possibilities: The cache system is not installed in the old and in the new site; The cache system is not installed in the old site and it is installed in the new site; The cache system is installed in both the old and the new sites; or the cache system is installed in the old site and it is not installed in the new site.

The first two cases are transparent to the cache system.

Regarding the second case, (cache is installed in both old and new sites): it can be assumed that each local cache holds an updated table with the information regarding the network RNCs identification and their associated local caches (in LTE, information regarding its neighbors eNodeB). Thus, the local cache of the old site can distinguish between the cases.

Generally, while serving small web cache requests we will serve the small requests in the old site and then close the relevant connections. However, if a large object is currently served (Video/P2P) we will handover the request to the next local cache (case c) or to the Root cache (case d).

Specifically, for web cache, while performing the SRNS relocation/handover procedure, the local cache of the old site should terminate the active web requests using “HTTP Connection: close” command to avoid handover of short requests. In addition, it stops serving requests on new connections.

While performing SRNS relocation/handover procedure, the old local cache should be able to send an information element to another local cache (associated with the new site) and to the Root cache with user line information (out-of band control message).

The local cache should be able to close a TCP connection using HTTP close command.

For large video/P2P objects, the request will be handover to the local cache associated with the new site (or to the Root cache in case d). It will continue to serve the request from the exact offset according to the handover request.

The local cache should be able to handover a TCP connection to another local cache or to the Root cache.

The local cache and the Root cache should be able to continue a TCP connection from the handover point as described below.

TCP Handover from a Local Cache to Another Local Cache or to the Root OC

To support these requirements, each local cache and the Root cache should have an agent waiting for TCP handover requests. Once a TCP handover request arrives, the agent creates the proper connection using the information on Source IP, Destination IP (will be the Root cache IP), Source port, Destination port, DL sequence number, and UL sequence number. The requested object will be served from the marked offset on this connection.

Regarding solutions at different locations (not in the eNodeB) such as low/high aggregation points, the handover can be identified using the messages (path switch and handover requests). Using the TEID key, the switched tunnel can be identified and the manipulation can continue. Again, the local cache should know the local caches addresses of its neighbors—to handover the TCP connections (if necessary).

Regarding the number of supported handovers, since the SRNS relocation procedure is very rare, the performance requirement in HSPA network is very weak; however, in LTE network the performance requirement is quite strong

Video Cache LTE Combined Flows

In the partial coverage caches can be deployed in any location within the RAN. An cache Covers all the e-NodeB's that where it is in the path of the data and LTE control messages to the MME, except e-NodeB's which are covered by “lower-layer” cache.

Since the RAN is hierarchal, each eNodeB may be covered by exactly one cache.

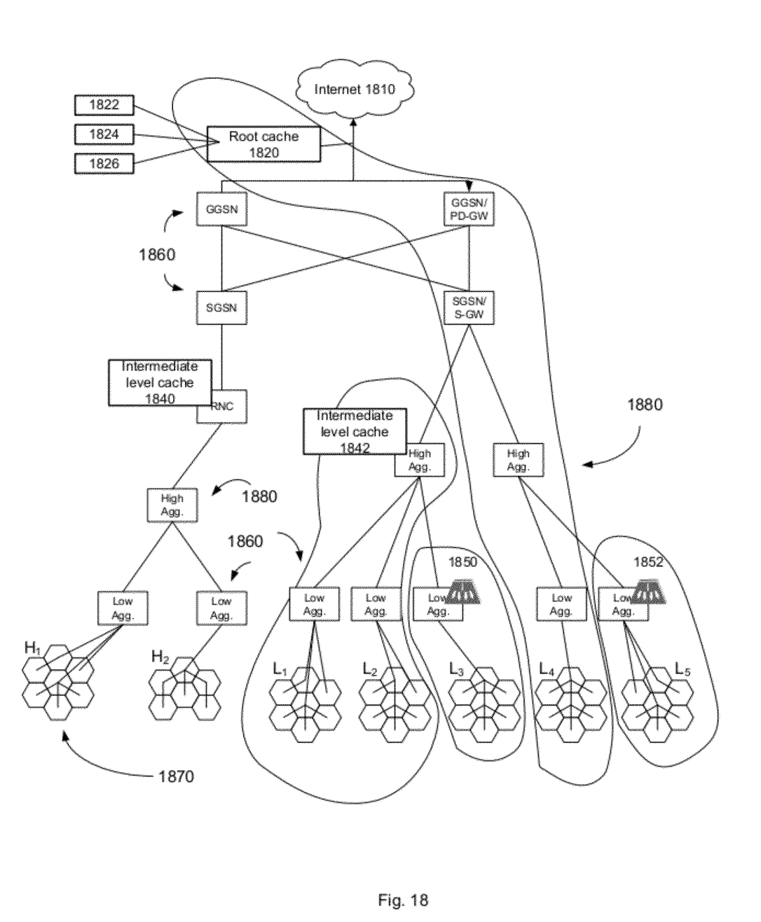

For example in, FIG. 18 illustrates internet 1810 that is coupled to a IP core network that includes GGSN, GGSN/PD-GW, SGSN and SGSN (collectively denoted 1860). The IP core network is also coupled to a RAN that includes high level aggregators (High Agg.) 1880, low level aggregators (Low Agg.) 1860 that in turn serve multiple cells 1870.

Local caches residing within/above RNCs cover all cells in the HSPA (H1, H2 cell groups) network.

Intermediate level cache 1842 covers two groups of eNodeBs: L₁ and L₂

First level cache 1850 covers group L₃ of eNodeBs

First level cache 1852 covers group L₅ of eNodeBs

Root cache 1820 covers the rest of the network and specifically group L₃ of eNodeBs which are not covered by any other Local caches.

Since all eNodeBs are covered by a least one cache (Local or the Root cache) There is no difference in the actual flows between the cases.

For handovers that fall between eNodeBs that are covered by the same Local cache, the only operation should be the correct tracking of the new GTP tunnels created during the handover for existing connections.

A hierarchical group of caches may include a root cache and other caches such as first level caches and intermediate level caches. The Root cache may be a single entity located in the Mobile core IP network, while the local cache are multiple independent caches located within the Radio Access Network (e.g., RNC in HSPA, e-NodeB in LTE).

The root cache 1820 may include:
a. A Cache Manager 1822 (referred as HP and/or as PM)—This element detects requests for cacheable content and redirect the request to the Root cache servers (HTTP requests for video, HTTP announces for BitTorrent/P2P).
b. Cache memory 1824—This element receives the requests (if not hijacked by the Local cache) and serves them. The cache can serve both HTTP Video and BitTorrent files (A hybrid cache)
c. BLM (Content Location Manager) 1826—This element maintain the Root cache file index, if the HM needs to redirect according to file availability.

FIG. 18 illustrates root cache 1820 as including HM 1822, cache 1824 and BLM 1826. These components can be integrated, located at the same location or located at different locations.

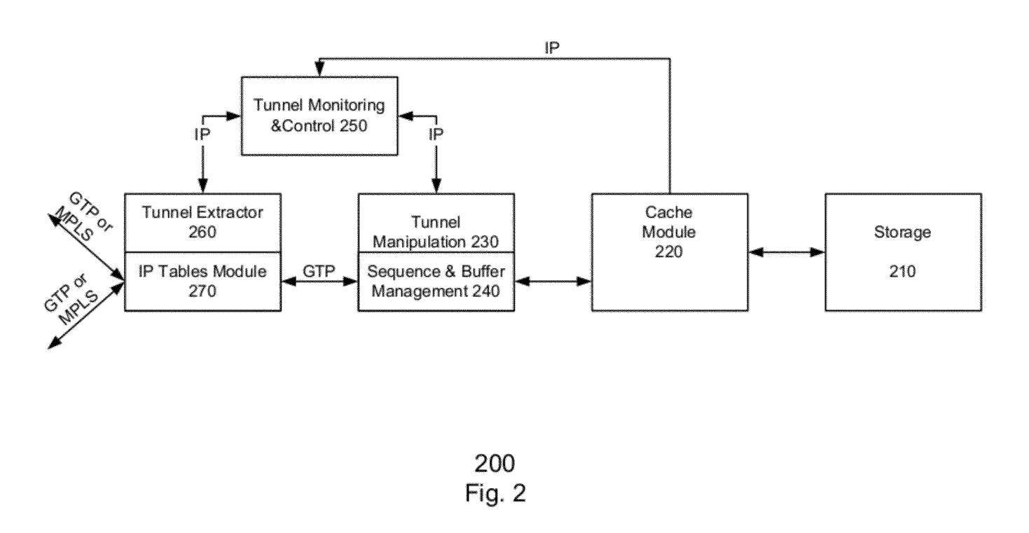

A cache that differ from a root cache (first level cache or intermediate level cache—also referred to as a local cache) may be divided into the following components (see FIG. 2):
a. Mobile Tunnel Extractor (Tunnel Extractor) 260—This element extracts the GTP flows, and sends them to the next element for further manipulation. Extraction can be done according to static or dynamic configuration: Forward all port 80; Forward according to destination IP Address (e.g. Root-cache IP Addresses). Forward according to dynamic destinations instrumentation—5-Tupple (Protocol, Source IP/PORT, Destination IP/Port); All other flows shall be returned to the network unchanged.
b. Tunnel Monitoring (tunnel monitoring and control) 250—This element monitors the GTP tunnels using the control channel and maintain their status in case the cache require intervention within one of the flows.
c. Mobile Tunnel Modifier (tunnel manipulation) 230—This element maintains the GTP tunnels, and allow for traffic injection into them. This is actually a back to back proxy, maintaining separate state machine for each side of the connections.
d. Cache module 220—This element implements the cache logic and delivery protocol. This module Will operate on the TCP Level and should maintain a state for each TCP connection (i.e. will be able to receive TCP sessions without the initial 3-way handshake. The actual caching module can act like WebServer, IP level proxy, or Transparent HTTP proxy (Squid).
   i. Web server (not shown), will use HTTP redirection in case the requested content is not available.
   ii. IP level proxy—able to switch between the original content and the cached content in a middle of a TCP session.
   iii. HTTP Proxy—Operates as a web proxy, terminates each HTTP connection and proxy it to the original server if needed (Back 2 Back).
e. Storage 210—This module is a remote or local storage element providing the cache module the actual content. A single storage module can serve multiple Cache modules, sharing the same content.

The Root cache may be located within the Core IP network with a similar functionality to commercially available web caches.

Local Cache

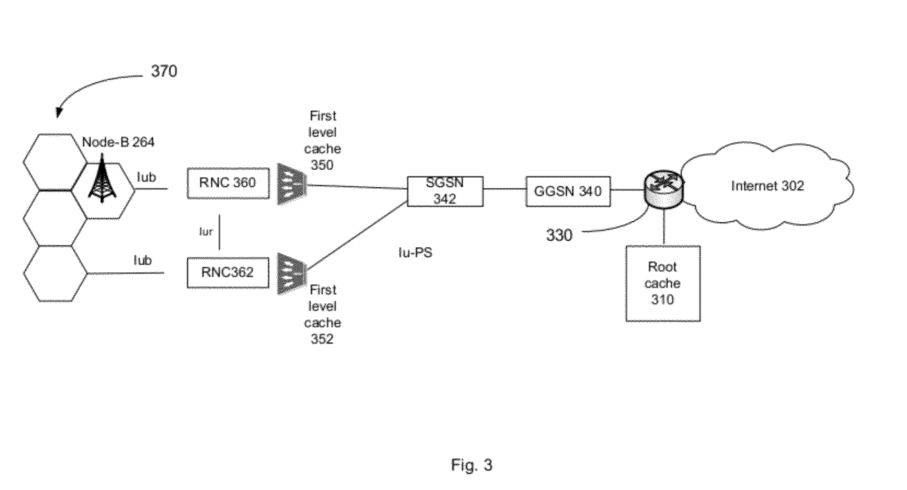

The system components of an HSPA network are plotted at FIG. 3 and include a GGSN 340 that is coupled to SGSN 342 that in turn is coupled to multiple RNCs such as RNCs 360 and 362, each of them is coupled to NodeB and multiple cells such as Node B 264 and multiple cells 370. A redirector 330 is coupled between the Internet 302m and root cache 310. Local caches such as first level caches 350 and 352 are coupled to RNCs 2650 and 262 respectively. The local cache can be implemented as an integrated part of the RNC or it can be implemented as a standalone system located at a switch on the Iu-PS interface. If the local cache is integrated inside the RNC it should be connected to the Traffic Processor/Line card that is responsible for the Iu-PS interface. Since there are limited number of RNC (In the order of 10s), each handling 100-500K users, and each cache can be an almost independent cache, with a considerable storage.

This solution may exhibit the following benefits: Sizing—several 10s of Local cache systems,

Simple GTP—No encryption in the tunneling protocol and Infrequent handovers between RNCs.

LTE Network

Regarding the actual location within LTE network, three possible solutions are described (and combinations of solutions):

Implementation of the local cache as an integrated part of the eNodeB (at the S1 interface) or as a standalone system at the cell gateway.

Implementation of the local cache at any location within the aggregation network (low aggregation point or high aggregation point), in such points where the cache will be able to detect all handovers using the S1 interfaces.

Implementation of the functional cache modules of the local cache at the e-NodeBs while the storage servers will be located within the aggregation networks, and connection between them will use a WAN/LAN protocol as WebDAV/iSCSUNFS.

This separation shall achieve two targets: Reduce the COGS: Storage blades are expensive, especially within places like e-NodeB where we should use SDD. The local storage may reside in a more relaxed environment allowing for an enterprise level redundancy. Increase the hit ratio: More users share the same storage, allowing for a larger storage and increasing hit probability.

LTE e-NodeB

In LTE network the Local cache can be located near (or within) the e-NodeB. In this case, the local cache will have a limited capacity (CPU and storage). This solution an exhibit the following benefits: Savings of backhaul to e-NodeB's; No need for high capacity server—eNodeB handles several 100s concurrent users;

Local cache sees all handovers—can use X2 object buffer forward functionality to continue handle the cached object.

The Local cache will use this information in order to provide an undisturbed service during handovers where User roam from an area covered by a local cache other area covered by the same local cache. User roam from an area covered by a local cache to area covered by different local cache. User roam from an area covered by a local cache to area not covered by a local cache—in this case the service will be continued by the Root cache which covers all the network.

LTE Low Aggregation Pt. (Just Above e-NodeB, e.g. e-NodeB Access Box)

This location is the first aggregation level just above the eNodeB's. In this level, local cache capacity should be around several 100s Mbps (with some location with 1-2 Gbps). In this level, the local cache should be able to handle MPLS traffic in order to get to the GTP protocol. This solution can exhibit the following benefits: Better hit ratio for a smaller total storage space—better storage utilization. Mixed eNodeB/LTE Low Aggregation pt.

In this setup the local cache functional modules will reside within (or near the e-NodeB), as computing blades, while the storage module will reside within the aggregation points. (can also put both together in the eNodeB and use the storage locally). In this level, local cache should be able to use MLPS while communicating with the storage module.

It is noted that the local cache functional module can use local storage/memory as first level cache (probably free if using WebDAV, assuming the file system is read only).

This solution can exhibit the following benefits : Lower system costs (single server in each e-NodeB+several (e.g. 10% of the e-NodeBs) Storage modules in strategic places within the aggregation network). Flexible Storage Cost/Hit ratio tradeoffs. Storage units can be in a gradual manner according to sizing and needs. Better hit ratio for a smaller total storage space—better storage utilization Account for all handovers.

Mixed eNodeB/LTE Low Aggregation Pt/LTE High Aggregation Point.

In this setup the local cache functional modules will reside within some of the (or near the e-NodeB), as computing blades, while the storage module will reside within the aggregation points—low and high. In this level, local cache should be able to use MLPS while communicating with the storage module.

This solution can exhibit the following benefits: Lower system costs (single server in each e-NodeB+several (e.g. 10% of the e-NodeBs) Storage modules in strategic places within the aggregation network). Flexible Storage Cost/Hit ratio tradeoffs. Storage units can be in a gradual manner according to sizing and needs. Better hit ratio for a smaller total storage space—better storage utilization.

Quality of Service Management and Control Flows.

Various QoS handling and control plane flows may be provided. The control flows may include both the internal system control and relevant user control flow.

Basic Redirection/Routing guidelines—There may be multiple operation methods available for the system such as HM redirect and transparent web-proxy.

HM redirect may include: redirecting to Root cache IP Addresses; Local cache shall monitor the Root cache IP Addresses and grab the flow if content exists locally; and The BLM has a central index of cached content in Root cache.

Internal Control Flows

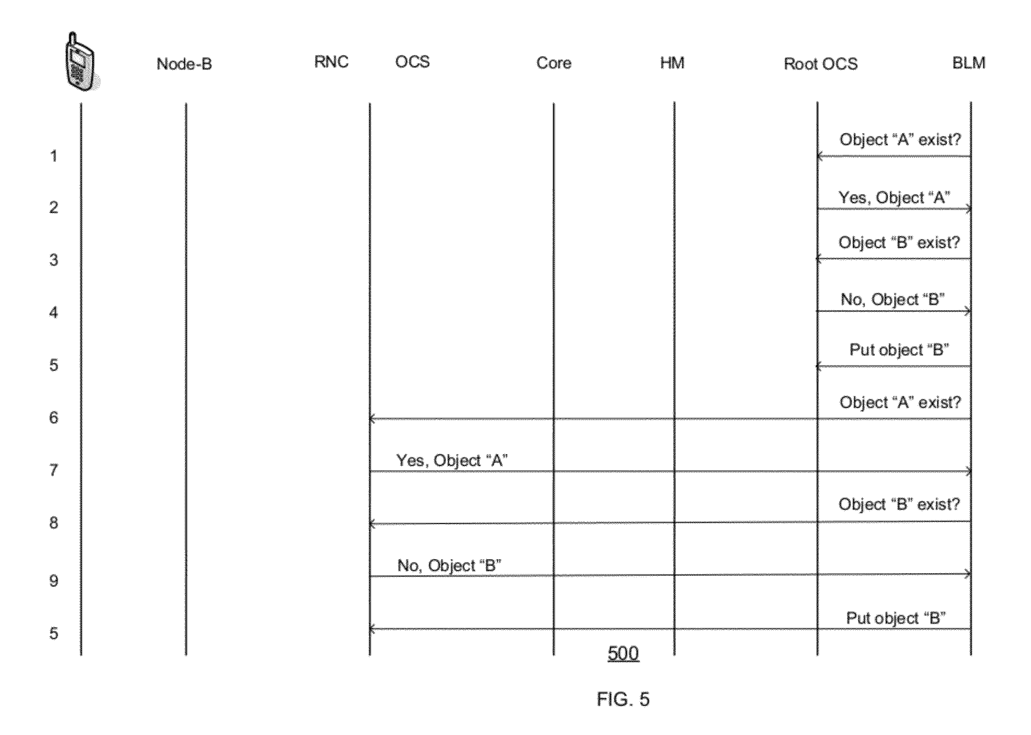

The first internal control flow 500 is described in FIG. 5.

In this scenario, the BLM pushes content either into the Root cache or into a specific local cache. For each case, the figure plots a positive response to the question regarding the existence of an object and a negative response. If the response is negative, the object is pushed into the relevant cache.

There may be multiple requirements on the mobile cache BLM, such as: The BLM should support a time event trigger to push operation. That is, it can activate a push operation in a specific predefine time. The BLM should support a geographic correlation between content and cache topology. That is, it can identify a geographic specific content and push it to the corresponding local cache serving this geographic area.

The BLM should support two level thresholds—high and low. The high level threshold will be used to instruct content download during busy-hour time and the low level threshold will be used to instruct content download during off-peak times.

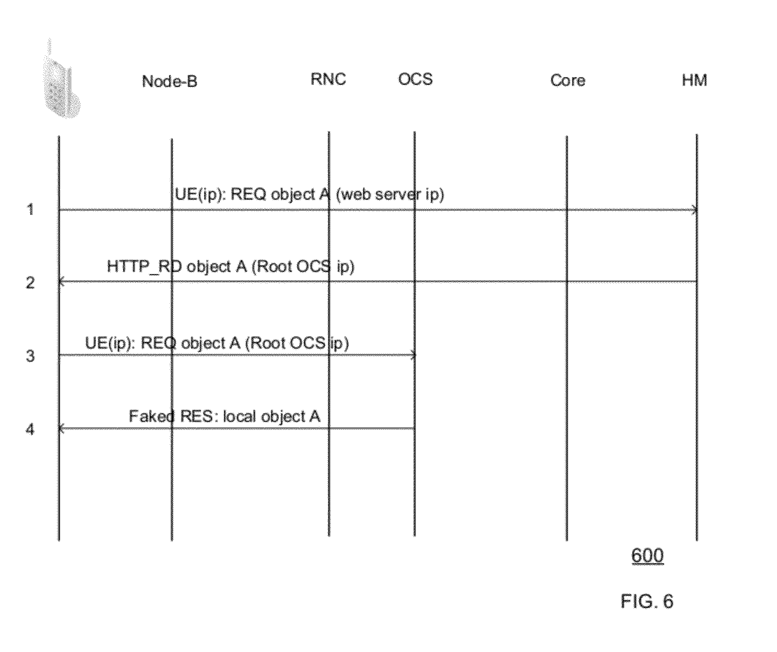

The simplified message flows between the cache system components upon arrival of a user request for content are further described in FIGS. 6-8. These figures illustrate the HM redirect and the transparent web-proxy. It is noted that a more detailed descriptions of “faked responses” of the mobile cache system are provided in the next section (detailed integration of the system into 3G network).

Internal Control Flows—HM Redirect.

FIG. 6 includes a control flow 600 of a simple case in which the local cache (the cache corresponding to the UE's SRNC) has the requested object A (local cache hit). At step 1, the UE generates a request for content “A”. The request is routed to the HM (using any known method, such as IP proxy, protocol proxy, DNS etc.). Assuming that the HM identifies the requested object “A” as possible hit (the BLM knows that the Root cache has it) it generates an HTTP_RD response to the UE with the IP address of the Root cache. The UE generates a new request to the object “A” from the IP address of the Root cache (step 3). The corresponding local cache already activated its inspection on this user traffic (while replying to the query on the UE), replies with the faked object “A” (step 4).

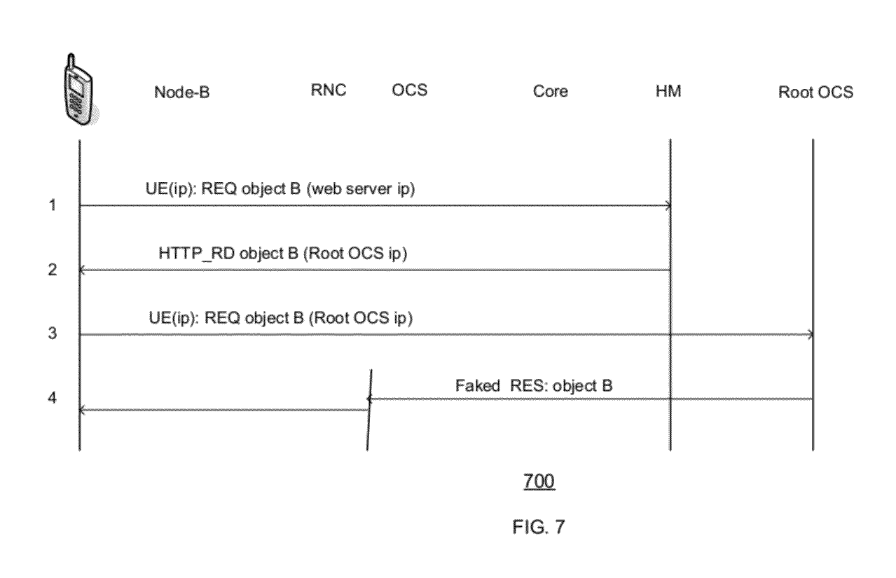

FIG. 7 includes a control flow 700 of a case in which the local cache does not have the requested object B (local cache miss) and a copy of B is stored in the Root cache (Root cache hit). At step 1, the UE generates a request for content “B”. The request is routed to the HM. Assuming that the HM identifies the requested object “B” as possible hit (the BLM knows that the Root cache has it) it generates an HTTP_RD response to the UE with the Root cache IP address (step 2). The UE generates a new request to the object “A” from the IP address of the Root cache (step 3). Then the Root cache responses with the faked object “B” (step 4). The corresponding local cache already activated its inspection on this user traffic (while replying to the query on the UE), thus, it can store a local copy of “B” while “B” is delivered to the UE.

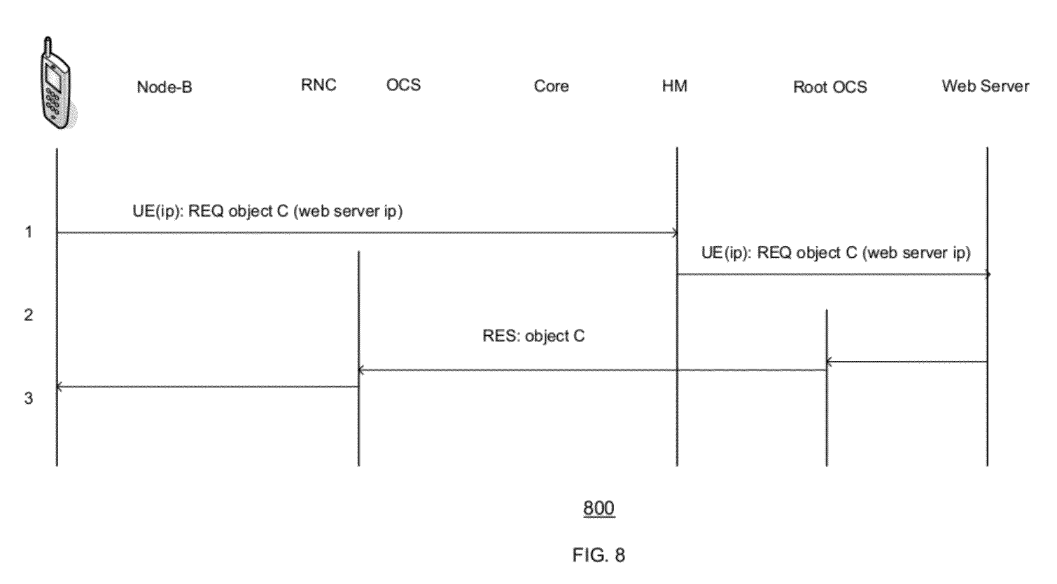

FIG. 8 includes a control flow 800 of a case in which the hierarchical cache does not have the requested object “C” (local cache miss and Root cache miss). At step 1, the UE generates a request for content “C”. The request is routed to the HM. Then, the HM understand that the Root cache does not have the object “C”, thus it forward the UE request to the original web server (step 2). At step 3, the web server responses with the object “C”. Note that object “C” is now stored at the Root cache and locally at the corresponding local cache.

Internal Control Flows—Transparent Web-Proxy.

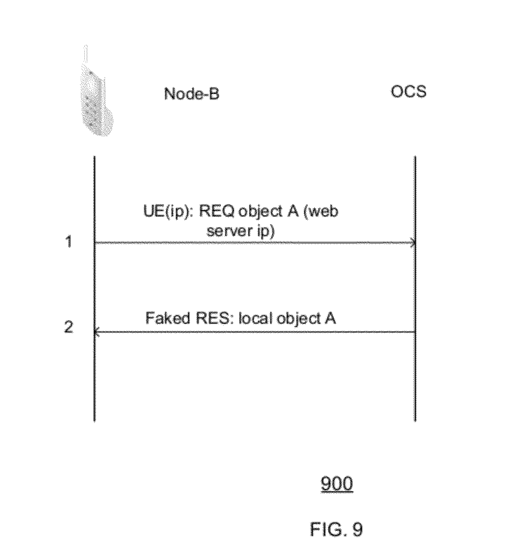

FIG. 9 includes a control flow 900 of a simple case in which the local cache (the cache corresponding to the UE's SRNC) has the requested object A (local cache hit). At step 1, the UE generates a request for content “A”. The request is routed to the local cache. It analyses the request and replies with the faked object “A” (step 2).

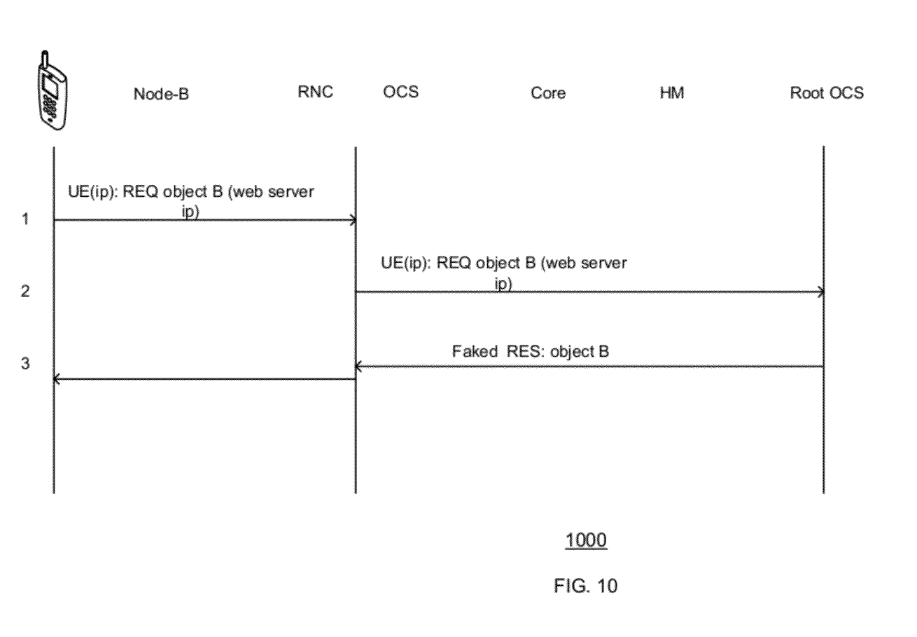

FIG. 10 includes a control flow 1000 of the case in which the local cache does not have the requested object B (local cache miss) and a copy of B is stored in the Root cache (Root cache hit). At step 1, the UE generates a request for content “B”. The request is routed to the local cache. The local cache analyses the request (local cache miss) and forward it to the Root cache (step 2). Then the Root cache responses with the faked object “B” (step 3). Note that object “B” is now stored locally at the corresponding local cache.

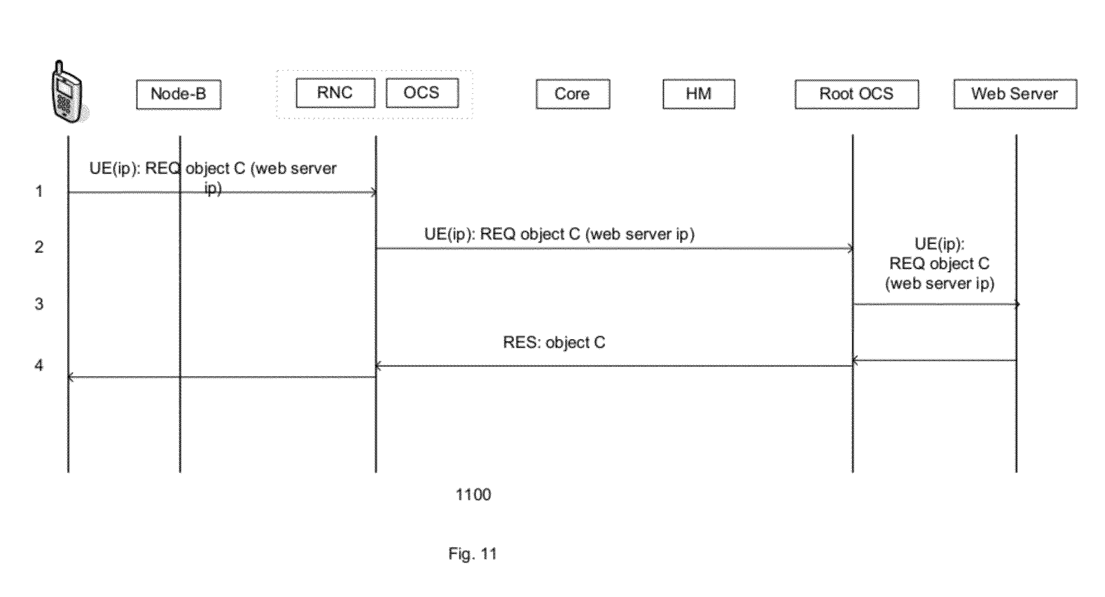

FIG. 11 includes a control flow 1100 of the case in which the hierarchical cache does not have the requested object “C” (local cache miss and Root cache miss). At step 1, the UE generates a request for content “C”. The request is routed to the local cache. The request is routed to the local cache. The local cache analyses the request (local cache miss) and forward it to the Root cache (step 2). Then the Root cache analyses the request (Root cache miss) and forward it to the web server (step 3). At step 4, the web server responses with the object “C”. Note that object “C” is now stored at the Root cache and locally at the corresponding local cache.

Mobility Support

HSPA Handovers Description

HSPA handovers can occur if Source Node-B and Target Node-B are controlled by the same RNC (C-RNC) or if source Node-B and Target Node-B are controlled by different RNCs.

Since the local cache is located at the Iu-PS interface of the RNC, the first case of handover is transparent to the cache system.

The second case of handover is more complex to manage. Usually, the C-RNC of the target Node-B become the D-RNC and the C-RNC of the source Node-B continue to be the S-RNC. Note that in this case, the user traffic path is Core network→S-RNC→D-RNC→serving Node-B (Target Node-B). As a result, the local cache system at the S-RNC (C-RNC of the source Node-B) continues to serve the user and again the handover is transparent to the cache system.

In some rare cases, the network decides to stop the flow through the Iur interface (S-RNC→D-RNC) and to perform a SRNS relocation procedure. As fully described in section 4.3.4.3 above, the D-RNC become the S-RNC and the GTP tunnel between the original S-RNC and the core network is released. This case is not transparent to the cache system and its solution is described below.

LTE Handovers Description

The following illustrates various procedures executed by the user equipment (UE) and the various network elements to provide the handover services requested by the UE.

In LTE there are three types of handovers: Intra-LTE: Handover happens within the current LTE nodes (intra-MME and Intra-SGW). Inter-LTE: Handover happens toward the other LTE nodes (inter-MME and Inter-SGW). Inter-RAT: Handover between different radio technology networks, for example GSM/UMTS.

Intra-LTE (Intra-MME/SGW) Handover Using the X2 Interface: This procedure is used to handover a UE from a Source eNodeB (S-eNB) to a Target eNodeB (T-eNB) using the X2 interface when the Mobility Management Entity (MME) and Serving Gateway (SGW) are unchanged. It is possible only if direct connectivity exists between the source and target eNodeB's with the X2 interface.

The X2 handover procedure is performed without Evolved Packet Core (EPC) involvement, i.e. preparation messages are directly exchanged between the S-eNB and T-eNB. The release of the resources at the source side during the handover completion phase is triggered by the T-eNB.

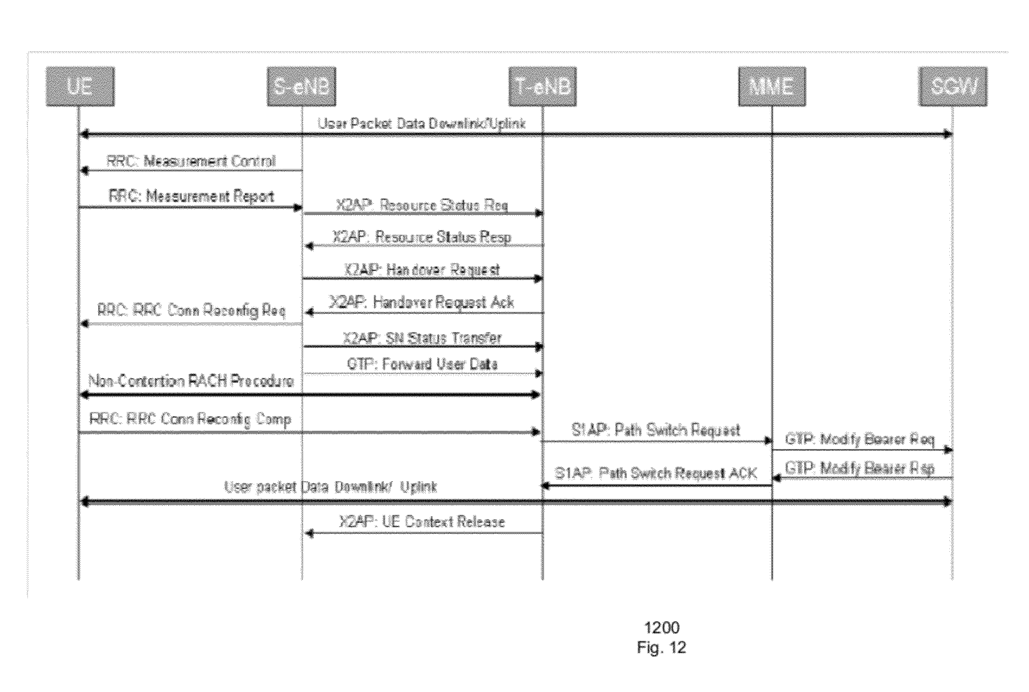

The message flow is this example is shown in FIG. 12 and may include the following:

A data call is established between the UE, S-eNB and the network elements. Data packets are transferred to/from the UE to/from the network in both directions (DL as well as UL).

The network sends the MEASUREMENT CONTROL REQ message to the UE to set the parameters to measure and set thresholds for those parameters. Its purpose is to instruct the UE to send a measurement report to the network as soon as it detects the thresholds.

The UE sends the MEASUREMENT REPORT to the S-eNB after it meets the measurement report criteria communicated previously. The S-eNB makes the decision to hand off the UE to a T-eNB using the handover algorithm.

The S-eNB issues the RESOURCE STATUS REQUEST message to determine the load on T-eNB (this is optional). Based on the received RESOURCE STATUS RESPONSE, the S-eNB can make the decision to proceed further in continuing the handover procedure using the X2 interface.

The S-eNB issues a HANDOVER REQUEST message to the T-eNB passing necessary information to prepare the handover at the target side (e.g., UE Context , which includes the Security Context and RB Context (including E-RAB to RB Mapping) and the Target cell info).

The T-eNB checks for resource availability and, if available, reserves the resources and sends back the HANDOVER REQUEST ACKNOWLEDGE message including a transparent container to be sent to the UE as an RRC message to perform the handover. The container includes a new C-RNTI, T-eNB security algorithm identifiers for the selected security algorithms, and may include a dedicated RACH preamble and possibly some other parameters (i.e., access parameters).

The S-eNB generates the RRC message to perform the handover, i.e, RRCCONNECTION RECONFIGURATION message including the mobilityControlInformation. The S-eNB performs the necessary integrity protection and ciphering of the message and sends it to the UE.

The S-eNB sends the eNB STATUS TRANSFER message to the T-eNB to convey the PDCP and HFN status of the E-RABs.

The S-eNB starts forwarding the downlink data packets to the T-eNB for all the data bearers (which are being established in the T-eNB during the HANDOVER REQ message processing).

In the meantime, the UE tries to access the T-eNB cell using the non-contention-based Random Access Procedure. If it succeeds in accessing the target cell, it sends the RRC CONNECTION RECONFIGURATION COMPLETE to the T-eNB.

The T-eNB sends a PATH SWITCH REQUEST message to the MME to inform it that the UE has changed cells, including the TAI (Tracking Area Identity)+ECGI (E-UTRAN Cell Global Identifier) of the target. The MME determines that the SGW can continue to serve the UE.

The MME sends a MODIFY BEARER REQUEST (eNodeB address and TEIDs for downlink user plane for the accepted EPS bearers) message to the S-GW. If the PDN GW requested the UE's location info, the MME also includes the User Location Information IE in this message.

The S-GW sends the downlink packets to the target eNB using the newly received addresses and TEIDs (path switched in the downlink data path to T-eNB) and the MODIFY BEARER RESPONSE to the MME.

The S-GW sends one or more “end marker” packets on the old path to the S-eNB and then can release any user plane/TNL resources toward the S-eNB.

The MME responds to the T-eNB with a PATH SWITCH REQ ACK message to notify the completion of the handover.

The T-eNB now requests the S-eNB to release the resources using the X2 UE CONTEXT RELEASE message. With this, the handover procedure is complete.

Intra-LTE (Intra-MME/SGW) Handover Using the S1 Interface:

The S1-based handover procedure is used when the X2-based handover cannot be used—e.g., no X2 connectivity to the target eNodeB; by an error indication from the T-eNB after an unsuccessful X2-based handover; or by dynamic information learnt by the S-eNB using the STATUS TRANSFER procedure. The S-eNB initiates the handover by sending a Handover required message over the S1-MME reference point. The EPC does not change the decisions taken by the S-eNB.

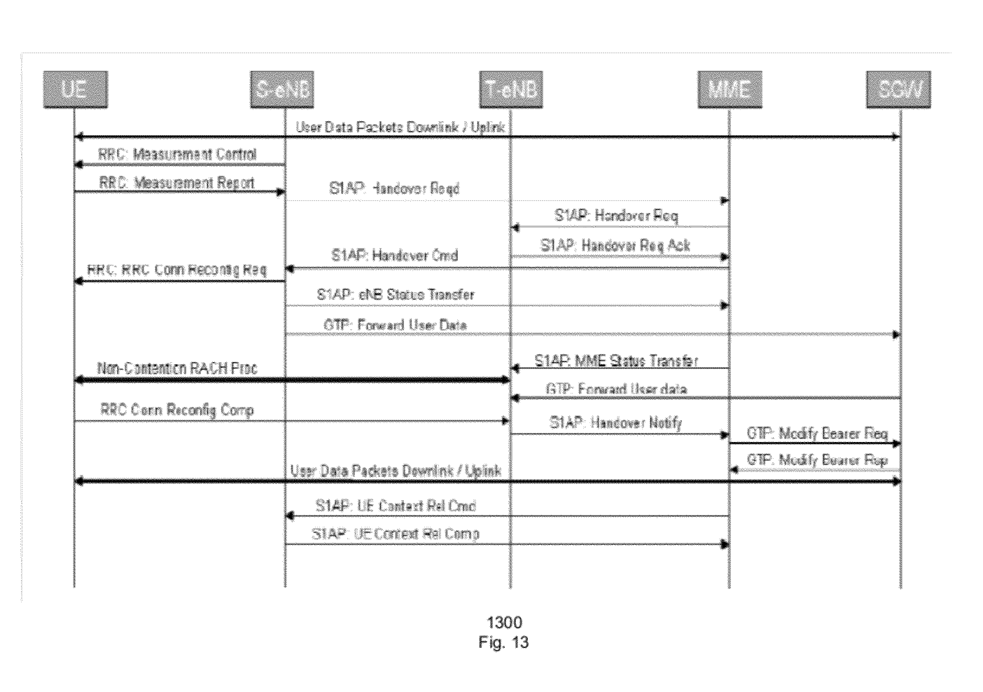

The availability of a direct forwarding path is determined in the S-eNB (based on the X2 connectivity with the T-eNB) and indicated to the source MME. If a direct forwarding path is not available, indirect forwarding will be used. The source MME uses the indication from the S-eNB to determine whether to apply indirect forwarding or not. The message flow 1300 is depicted in FIG. 13.

As mentioned in the previous section, based on the MEASUREMENT REPORT from the UE, the S-eNB decides to Handover the UE to another eNodeB (T-eNB). The handover procedure in this section is very similar to that in the previous section (Intra-LTE Handover Using the X2 Interface), except the involvement of the MME in relaying the handover signaling between the S-eNB and T-eNB.

There are two differences here: No need for the PATH SWITCH Procedure between the T-eNB and MME, as MME is aware of the Handover. The S-GW is involved in the DL data forwarding if there is no direct forwarding path available between the S-eNB and T-eNB.

Once the Handover is complete, the MME clears the logical S1 connection with the S-eNB by initiating the UE CONTEXT RELEASE procedure.

Inter-MME Handover Using the S1 Interface (Without Changing S-GW)

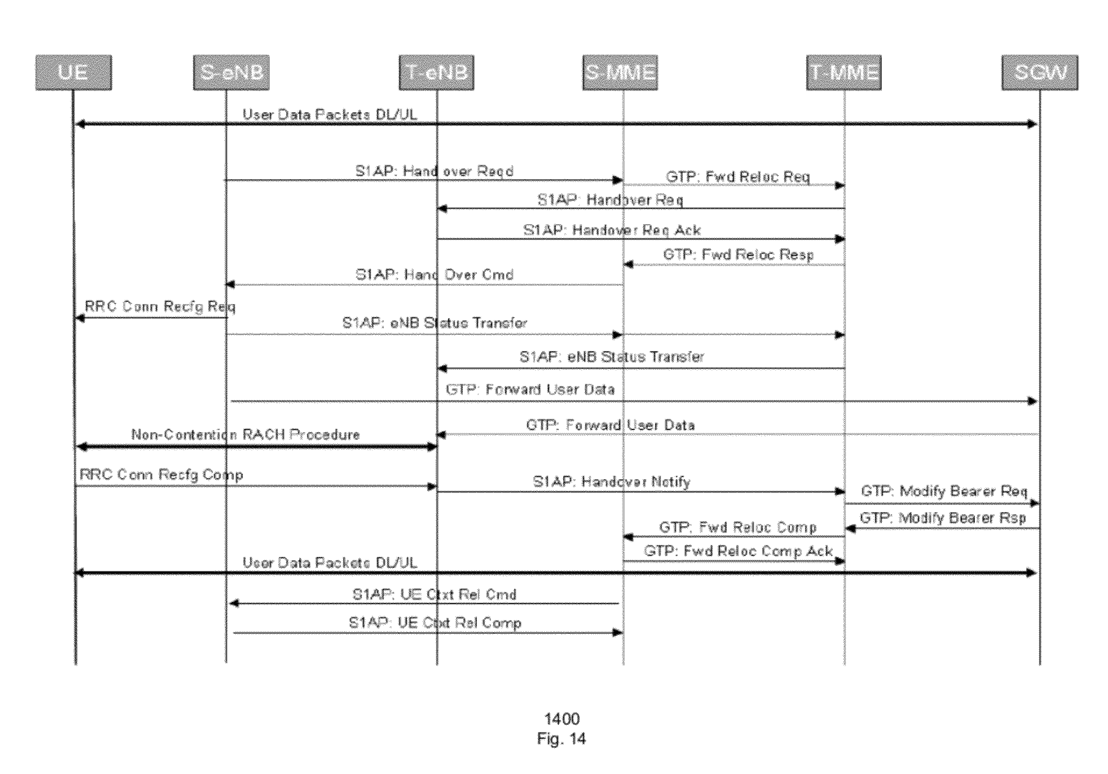

In an inter-MME handover, two MMEs are involved in the handover, the source MME (S-MME) and target MME (T-MME). The S-MME controls the S-eNB and the T-MME controls the T-eNB; both MMEs are connected to the same SGW. This handover is triggered when the UE moves from one MME area to another MME area. The message flow 1400 is depicted in FIG. 14.

As mentioned before (Intra-MME/SGW handover), based on the MEASUREMENT REPORT from the UE, the S-eNB decides to handover the UE to another eNodeB (T-eNB). The handover procedure in this section is very similar to that in the previous section except for the involvement of two MMEs coordinating the handover signaling between the source and target eNodeBs.

The S-MME uses GTP signaling to communicate the handover signaling to the T-MME and vice versa. The FORWARD RELOCATION procedure in GTP-C is being used here.

After receiving the S1 HANDOVER REQUIRED, the S-MME detects that the target cell requested for handover belongs to another MME and initiates the GTP FORWARD RELOCATION REQ message to the T-MME.

The T-MME creates the S1 logical connection toward the T-eNB and sends the S1 HANDOVER REQ on it.

The T-eNB prepares the requested resources and responds with a HANDOVER REQ ACK to the T-MME.

The T-MME sends a GTP FORWARD RELOCATION RESP to the S-MME, to notify the resource reservation at the T-eNB. From this point onwards, the interaction between the S-MME and S-eNB is very similar to the S1-based Intra-MME/SGW handover described in the previous section.

DL data packets are forwarded from the S-eNB to T-eNB via the SGW during the handover, as the SGW is not changed here.

Once the T-eNB detects the UE in its area, it notifies the T-MME with a S1 HANDOVER NOTIFY message.

The T-MME notifies the completion of the handover to the S-MME with a GTP FORWARD RELOCATION COMPLETE NOTIFY message.

The S-MME acknowledges the GTP FORWARD RELOCATION COMPLETE NOTIFY to the T-MME and proceeds with clearing the Si logical connection and the associated bearer resources.

Inter-MME/SGW Handover Using the S1 Interface

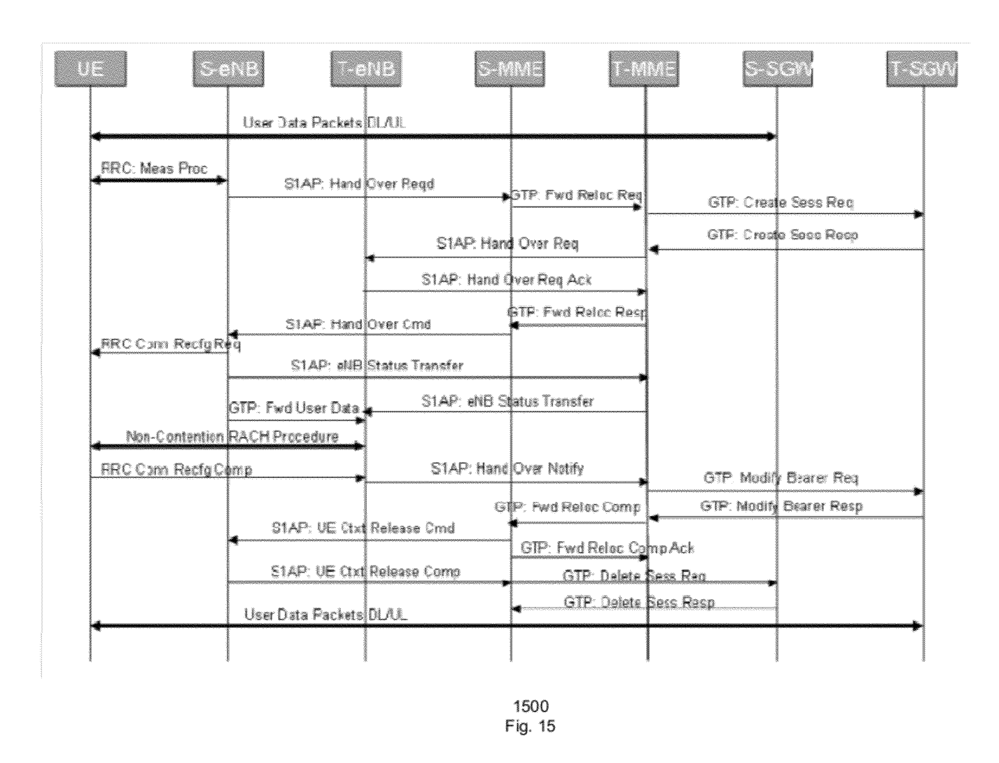

This scenario is similar to the previous section with the difference being the Source and Target eNodeBs are served by different MME/S-GW nodes. FIG. 15 depicts the procedures.

As described in the previous section (Inter-MME, Intra-SGW handover), based on the MEASUREMENT REPORT from the UE, the S-eNB decides to handover the UE to another eNodeB (T-eNB). The handover procedure in this section is very similar to that in the previous section, except for the involvement of two SGWs (S-SGW and T-SGW) to transfer the data packets during the handover.

After receiving the GTP: FORWARD RELOCATION REQ from the S-MME, the T-MME detects the SGW change and initiates the bearer creation toward the target SGW (T-SGW) using a GTP: CREATE SESSION REQ message.

After the creation of the requested bearers, the T-SGW responds back to the MME with a GTP: CREATE SESSION RESPONSE message.

From this point onward, the message flow is very similar to that in the previous section (Inter-MME, Intra-SGW handover) except for the following differences:

While processing the S1 HANDOVER NOTIFY message from the T-eNB, the T-MME updates the T-eNB endpoint information to the T-SGW using GTP: MODIFY BEARER REQ.

After updating the T-eNB information in the bearers (successfully set up during the handover), the T-SGW responds with a GTP: MODIFY BEARER RESPONSE message to the T-MME.

After successful completion of the handover, the S-MME takes care of releasing bearer resources with the S-SGW for this UE by initiating the GTP: DELETE SESSION procedure.

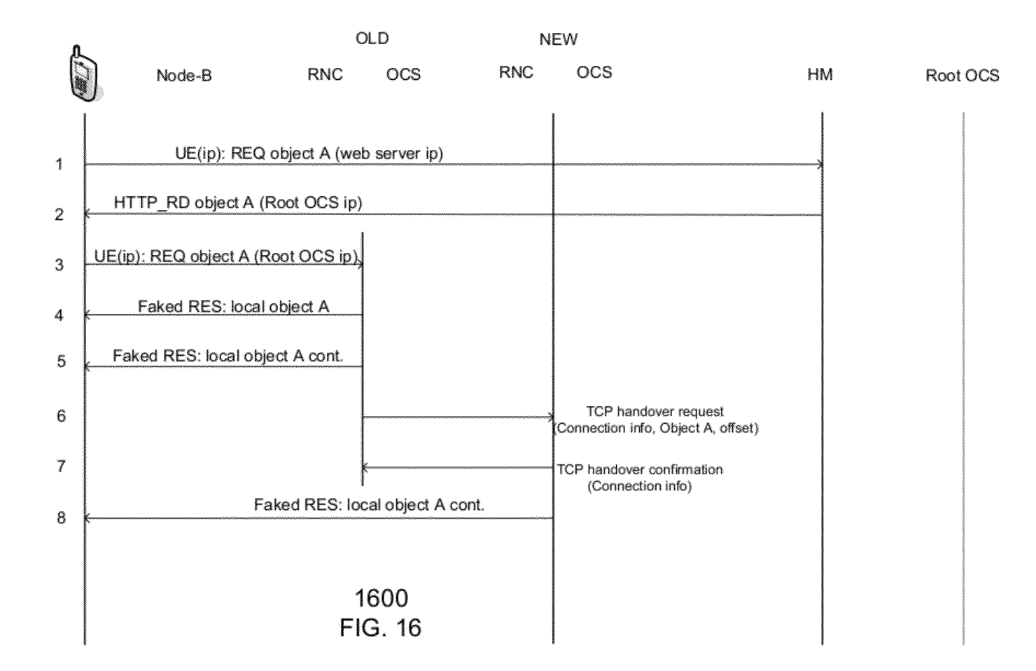

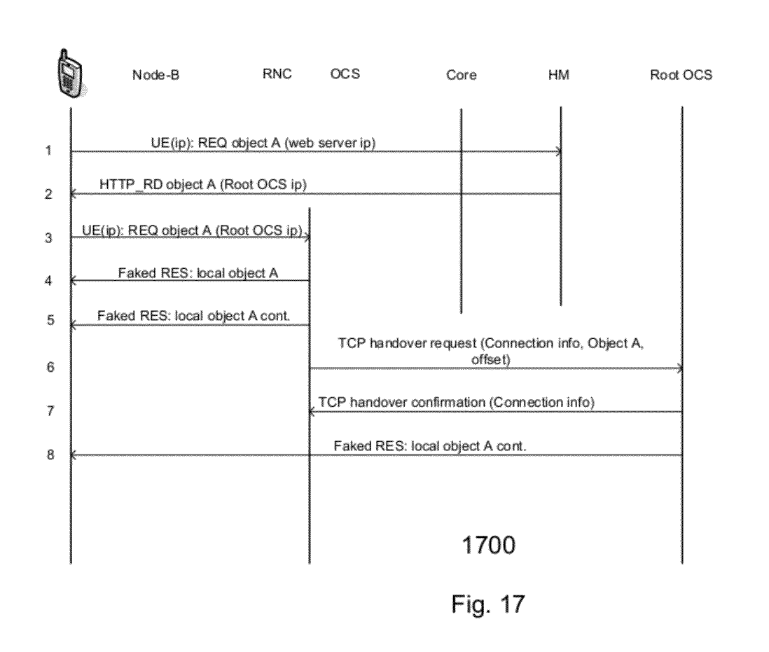

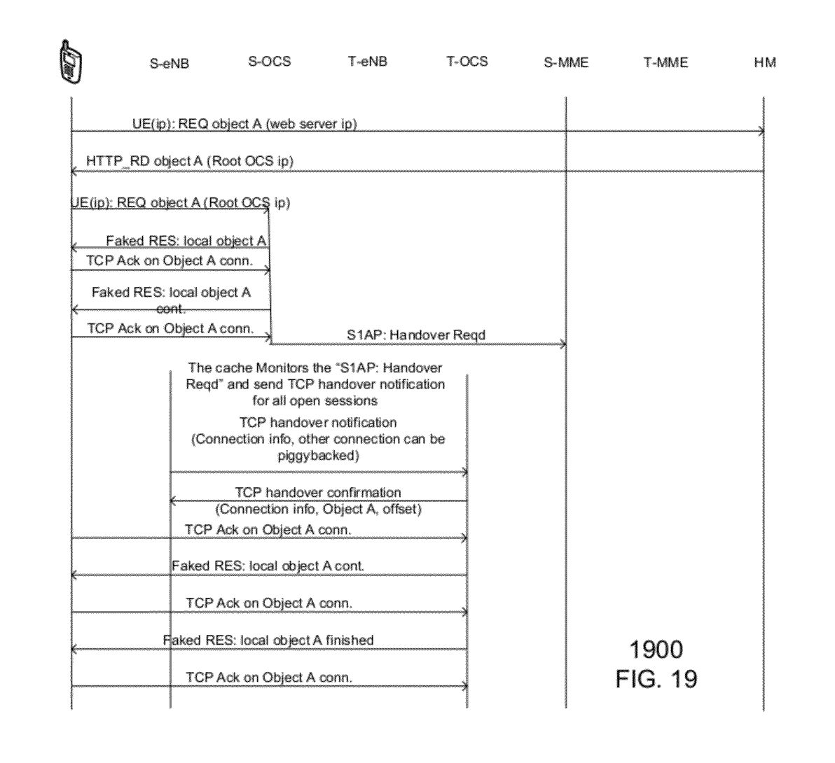

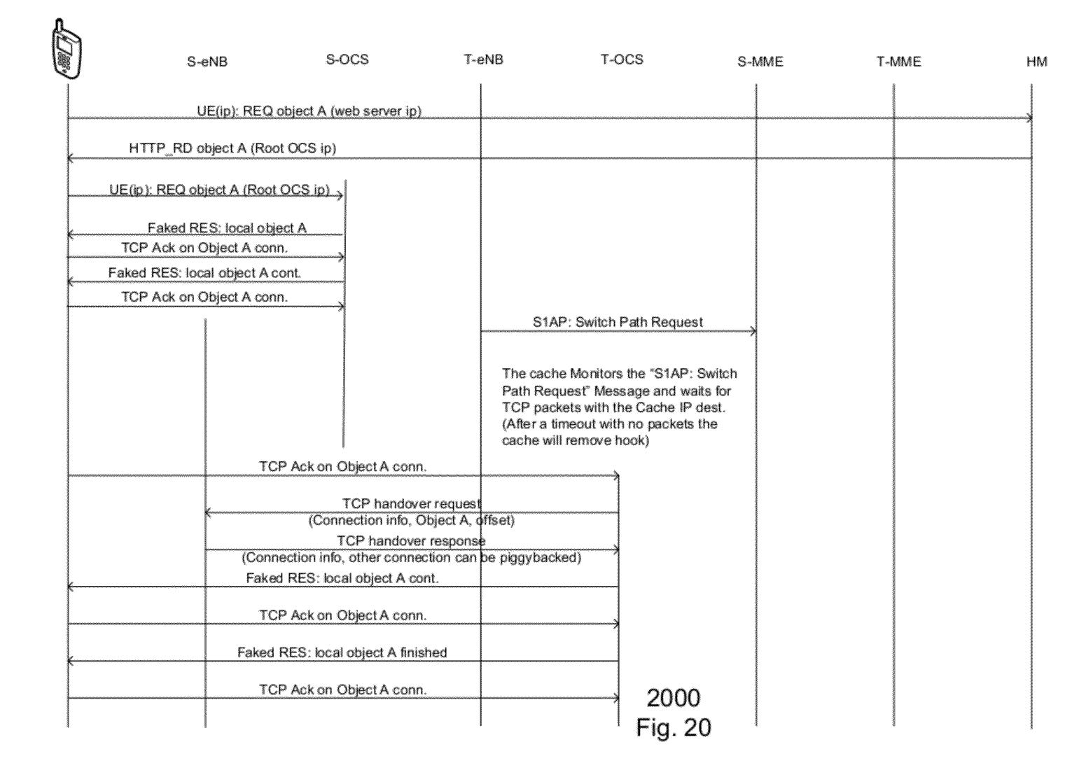

FIGS. 16-20 also illustrate various handovers (control flows 1600-2000) according to various embodiments of the invention.

There may be provided at least one of the following:

A Caching System that can be placed anywhere within the 4G (LTE) RAN (Radio Access Network) as substantially illustrated in the specification, and additionally or alternatively in the drawings.

A Caching System that can be placed above the RNC in 3G Network RAN (Radio Access Network) as substantially illustrated in the specification, and additionally or alternatively in the drawings.

A Method for providing undisturbed service during handovers where: User roam from an area covered by a local cache other area covered by the same local cache as substantially illustrated in the specification, and additionally or alternatively in the drawings.

A Method for providing undisturbed service during handovers where: User roam from an area covered by a local cache to area covered by different local cache as substantially illustrated in the specification, and additionally or alternatively in the drawings.

A Method for providing undisturbed service during handovers where: User roam from an area covered by a local cache to area not covered by a local cache as substantially illustrated in the specification, and additionally or alternatively in the drawings.

A Method for redirecting and “capturing” of traffic from the internet to the Caching System using a combination of IP level element and RAN level element as substantially illustrated in the specification, and additionally or alternatively in the drawings.

A Method for identifying traffic redirected to the caching system using RAN level element as substantially illustrated in the specification, and additionally or alternatively in the drawings.

A Method for identifying and relaying cache meta-data required for undisturbed service during handovers between areas covered by the same Local-caches as substantially illustrated in the specification, and additionally or alternatively in the drawings.

A Method for identifying and relaying cache meta-data required for undisturbed service during handovers between areas covered by different Local-caches as substantially illustrated in the specification, and additionally or alternatively in the drawings.

A Method for identifying and relaying cache meta-data required for undisturbed service during handovers where: User roam from an area covered by a local cache to area not covered by a local cache as substantially illustrated in the specification, and additionally or alternatively in the drawings.

FIGS. 16-20 also illustrate various handovers according to various embodiments of the invention.

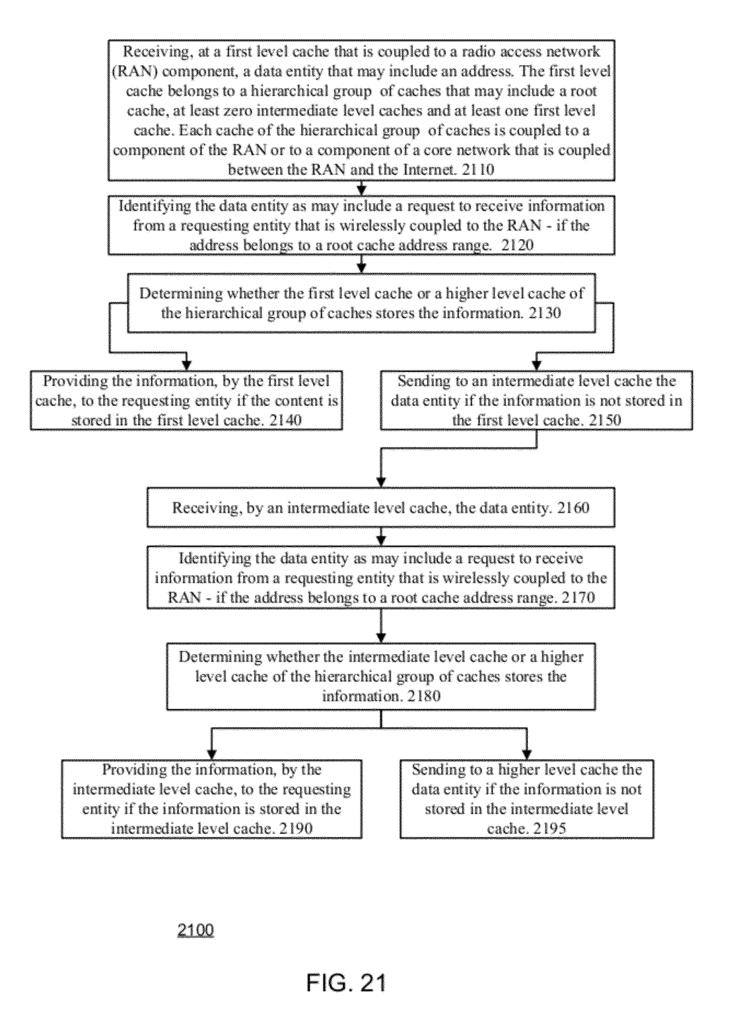

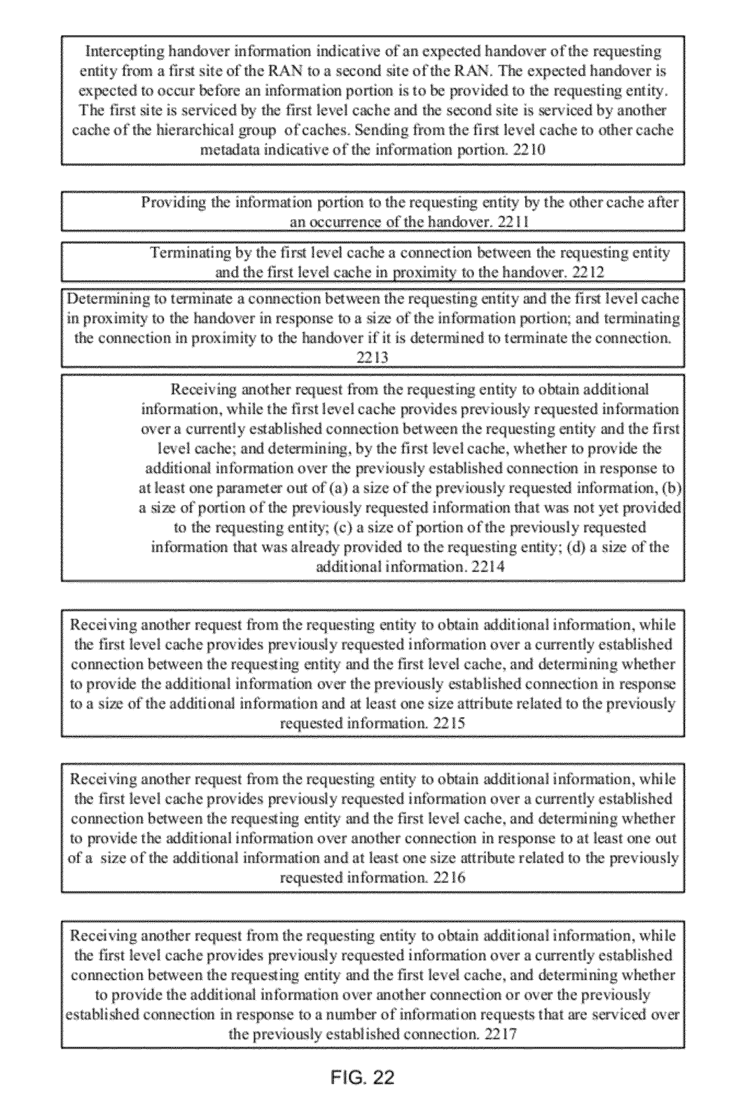

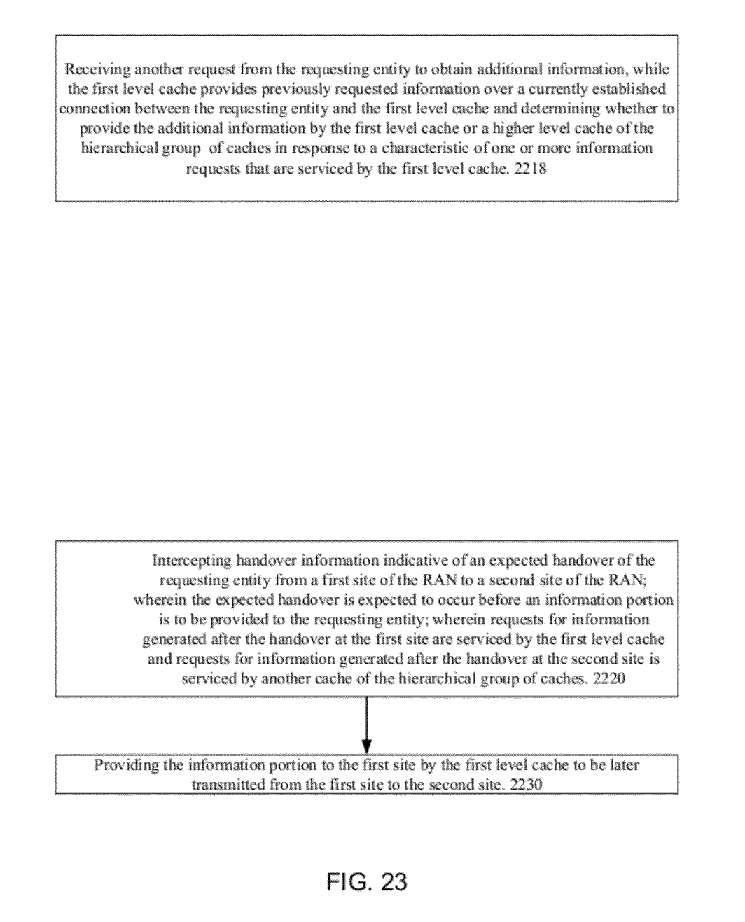

FIGS. 21-23 illustrate method 2100 according to an embodiment of the invention.

Method 2100 may include various stages such as stage 2110, 2120, 2130, 2140, 2150, 2160, 2170, 2180, 2190, 2195, 2210-2218, 2220 and 2230.

Stage 2110 may include receiving, at a first level cache that is coupled to a radio access network (RAN) component, a data entity that may include an address. The first level cache belongs to a hierarchical group of caches that may include a root cache, at least zero intermediate level caches and at least one first level cache. Each cache of the hierarchical group of caches is coupled to a component of the RAN or to a component of a core network that is coupled between the RAN and the Internet.

Stage 2110 may be followed by stage 2120 of identifying the data entity as may include a request to receive information from a requesting entity that is wirelessly coupled to the RAN—if the address belongs to a root cache address range.

Stage 2120 may be followed by stage 2130 of determining whether the first level cache or a higher level cache of the hierarchical group of caches stores the information.

Stage 2130 may be followed by stage 2140 of providing the information, by the first level cache, to the requesting entity if the content is stored in the first level cache.

Stage 2130 may be followed by stage 2150 of sending to an intermediate level cache the data entity if the information is not stored in the first level cache.

Stage 2150 may be followed by stage 2160 of receiving, by an intermediate level cache, the data entity.

Stage 2160 may be followed by stage 2170 of identifying the data entity as may include a request to receive information from a requesting entity that is wirelessly coupled to the RAN—if the address belongs to a root cache address range.

Stage 2170 may be followed by stage 2180 of determining whether the intermediate level cache or a higher level cache of the hierarchical group of caches stores the information.

Stage 2180 may be followed by stage 2190 of providing the information, by the intermediate level cache, to the requesting entity if the information is stored in the intermediate level cache.

Stage 2180 may be followed by stage 2195 of sending to a higher level cache the data entity if the information is not stored in the intermediate level cache.

Stages 2120 and 2170 of identifying may be executed without performing deep packet probing.

Stage 2210 may include intercepting handover information indicative of an expected handover of the requesting entity from a first site of the RAN to a second site of the RAN. The expected handover is expected to occur before an information portion is to be provided to the requesting entity. The first site is serviced by the first level cache and the second site is serviced by another cache of the hierarchical group of caches. Sending from the first level cache to other cache metadata indicative of the information portion.

Stage 2210 may be followed by either one of the following stages:
a. Stage 2211 of providing the information portion to the requesting entity by the other cache after an occurrence of the handover.
b. Stage 2212 of terminating by the first level cache a connection between the requesting entity and the first level cache in proximity to the handover.
c. Stage 2213 of determining to terminate a connection between the requesting entity and the first level cache in proximity to the handover in response to a size of the information portion; and terminating the connection in proximity to the handover if it is determined to terminate the connection.
d. Stage 2214 of receiving another request from the requesting entity to obtain additional information, while the first level cache provides previously requested information over a currently established connection between the requesting entity and the first level cache; and determining, by the first level cache, whether to provide the additional information over the previously established connection in response to at least one parameter out of (a) a size of the previously requested information, (b) a size of portion of the previously requested information that was not yet provided to the requesting entity; (c) a size of portion of the previously requested information that was already provided to the requesting entity; (d) a size of the additional information.
e. Stage 2215 of receiving another request from the requesting entity to obtain additional information, while the first level cache provides previously requested information over a currently established connection between the requesting entity and the first level cache, and determining whether to provide the additional information over the previously established connection in response to a size of the additional information and at least one size attribute related to the previously requested information.
f. Stage 2216 of receiving another request from the requesting entity to obtain additional information, while the first level cache provides previously requested information over a currently established connection between the requesting entity and the first level cache, and determining whether to provide the additional information over another connection in response to at least one out of a size of the additional information and at least one size attribute related to the previously requested information.
g. Stage 2217 of receiving another request from the requesting entity to obtain additional information, while the first level cache provides previously requested information over a currently established connection between the requesting entity and the first level cache, and determining whether to provide the additional information over another connection or over the previously established connection in response to a number of information requests that are serviced over the previously established connection.
h. Stage 2218 of receiving another request from the requesting entity to obtain additional information, while the first level cache provides previously requested information over a currently established connection between the requesting entity and the first level cache and determining whether to provide the additional information by the first level cache or a higher level cache of the hierarchical group of caches in response to a characteristic of one or more information requests that are serviced by the first level cache.

According to an embodiment of the invention the method may include stage 2220 of intercepting handover information indicative of an expected handover of the requesting entity from a first site of the RAN to a second site of the RAN; wherein the expected handover is expected to occur before an information portion is to be provided to the requesting entity; wherein requests for information generated after the handover at the first site are serviced by the first level cache and requests for information generated after the handover at the second site is serviced by another cache of the hierarchical group of caches; and stage 2230 of providing the information portion to the first site by the first level cache to be later transmitted from the first site to the second site.

Both Method 2100 and Method 2200 may be at least partially executed by a root cache that may cache all information stored in any other caches of the hierarchical group of caches.

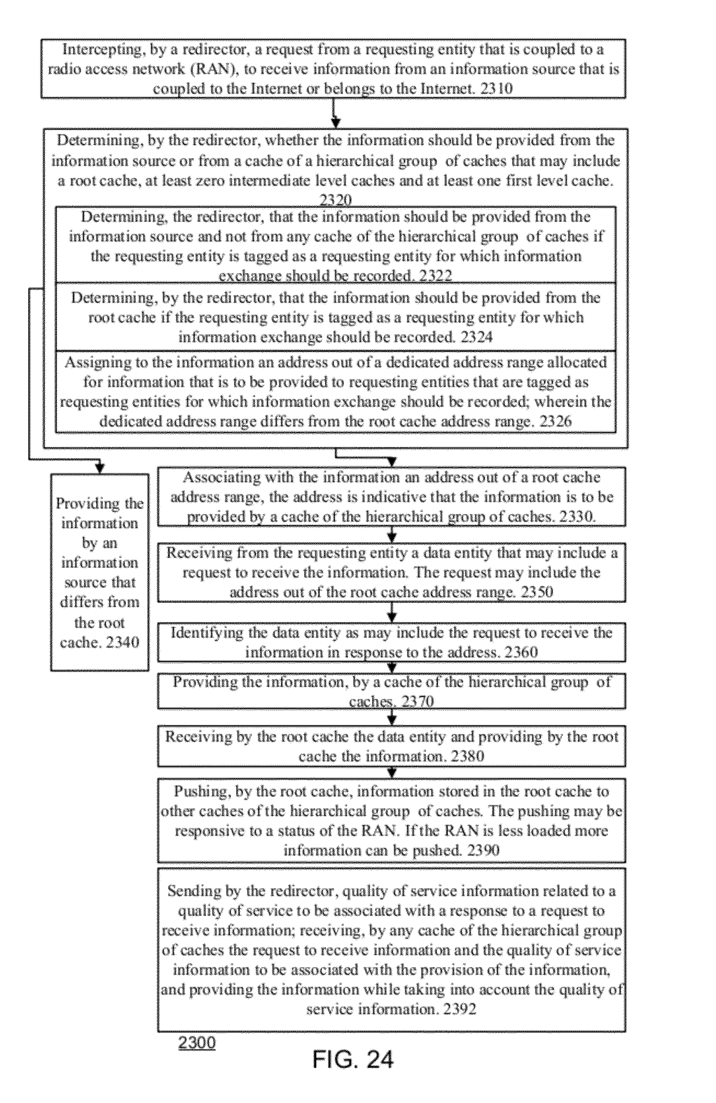

FIG. 24 illustrates method 2300 according to an embodiment of the invention.

Method 2300 and may include stages 2310, 2320, 2330, 2340, 2350, 2360, 2370, 2380 and 2390.

Stage 2310 may include intercepting, by a redirector, a request from a requesting entity that is coupled to a radio access network (RAN), to receive information from an information source that is coupled to the Internet or belongs to the Internet.

Stage 2310 may be followed by stage 2320 of determining, by the redirector, whether the information should be provided from the information source or from a cache of a hierarchical group of caches that may include a root cache, at least zero intermediate level caches and at least one first level cache. The determination may be responsive to the content stored in the root cache.

If it is determined to provide the information from the cache then stage 2320 may be followed by stage 2330 of associating with the information an address out of a root cache address range, the address is indicative that the information is to be provided by a cache of the hierarchical group of caches. Else—stage 2320 may be followed by stage 2340 of providing the information by an information source that differs from the root cache.

Stage 2350 may include receiving from the requesting entity a data entity that may include a request to receive the information. The request may include the address out of the root cache address range.

Stage 2360 may include identifying the data entity as may include the request to receive the information in response to the address.

Stage 2370 may include providing the information, by a cache of the hierarchical group of caches.

Stage 2380 may include receiving by the root cache the data entity and providing by the root cache the information.

Stage 2390 may include pushing, by the root cache, information stored in the root cache to other caches of the hierarchical group of caches. The pushing may be responsive to a status of the RAN. If the Ran is less loaded more information can be pushed.

Stage 2320 may include stage 2322 of determining, by the redirector, that the information should be provided from the information source and not from any cache of the hierarchical group of caches if the requesting entity is tagged as a requesting entity for which information exchange should be recorded.

Stage 2320 may include stage 2324 of determining, by the redirector, that the information should be provided from the root cache if the requesting entity is tagged as a requesting entity for which information exchange should be recorded. Wherein if it is determined that the information should be provided from the root cache than stage 2324 may be followed by stage 2326 of assigning to the information an address out of a dedicated address range allocated for information that is to be provided to requesting entities that are tagged as requesting entities for which information exchange should be recorded; wherein the dedicated address range differs from the root cache address range; or by adding additional tagging to the information

Method 2300 or any other method mentioned in the specification can further include stage 2392 of sending by the redirector, quality of service information related to a quality of service to be associated with a response to a request to receive information; receiving, by any cache of the hierarchical group of caches the request to receive information and the quality of service information to be associated with the provision of the information, and providing the information while taking into account the quality of service information. The latter may include allocating bit rate, prioritizing the transmission of the information, opening or maintaining more than one connection over which the information should be provided, and the like. It is noted that the quality of service information can be replaced by any other information that may affect the manner in which the information should be provided to the requesting entity.

Any of the mentioned above root caches can be an out of band root cache. The root cache can belong to a core network or be coupled to a component of the core network. The core network is coupled between the Internet and the RAN.

The root cache can be an out of band root cache as it does not receive the transferred information or content but receives the requests to receive the content and any control signals that may assist in the caching of content, and or transferring the content.

Each cache may be located in any location of the RAN hierarchy covering the RAN fully or partially.

The group of hierarchical caches can be regarded as hierarchical not just as including different level of cache but as each cache may cache all the information that is caches in lower level caches that are associated with that cache. Thus, a root cache can store all the information cached in the group. An intermediate level cache that supports multiple sites of a RAN may cache all the information that is cached by any lower level cache that support any of these sites.

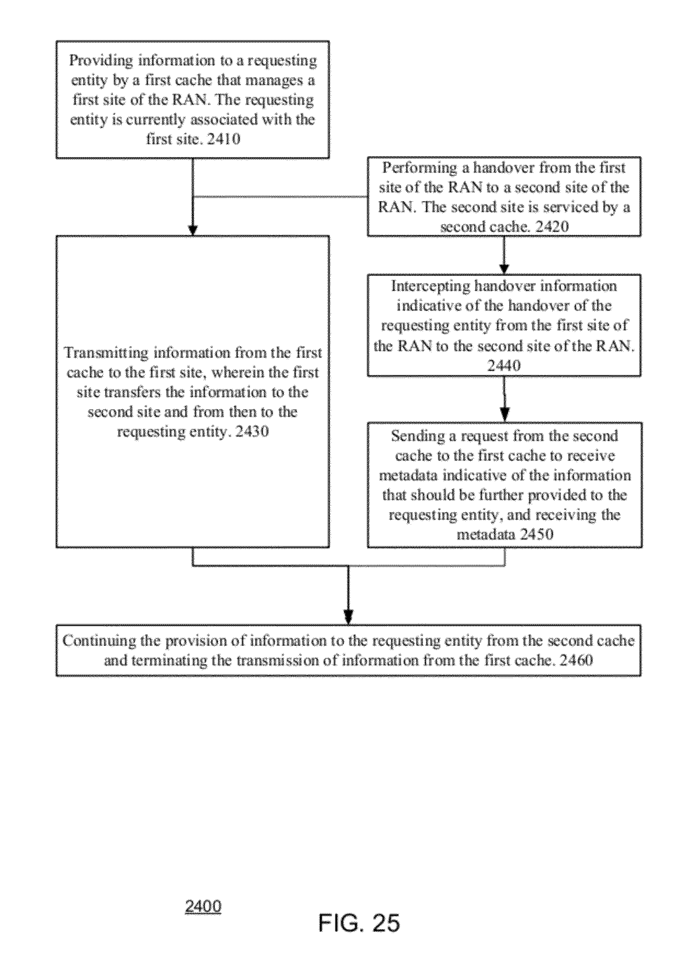

FIG. 25 illustrates method 2400 according to an embodiment of the invention.

Method 2400 may manage handovers in cases where the handover occurs before handover information indicative of the handover is intercepted by the root cache or any other member of the hierarchical group of caches.

Method 2400 may start by stage 2410 of providing information to a requesting entity by a first cache that manages a first site of the RAN. The requesting entity is currently associated with the first site.

Method 2400 may also include stage 2420 of performing a handover from the first site of the RAN to a second site of the RAN. The second site is serviced by a second cache.

Stages 2420 and 2410 are followed by stage 2430 of transmitting information from the first cache to the first site, wherein the first site transfers the information to the second site and from then to the requesting entity. For a point of view of the first cache the provision of information does not change. The RAN network is arranged to direct the information from the first site to the second site.

Stage 2420 may also be followed by stage 2440 of intercepting handover information indicative of the handover of the requesting entity from the first site of the RAN to the second site of the RAN.

Stage 2440 is followed by stage 2450 of sending a request from the second cache to the first cache to receive metadata indicative of the information that should be further provided to the requesting entity, and receiving the metadata.

Stages 2450 and 2430 are followed by stage 2460 of continuing the provision of information to the requesting entity from the second cache and terminating the transmission of information from the first cache.

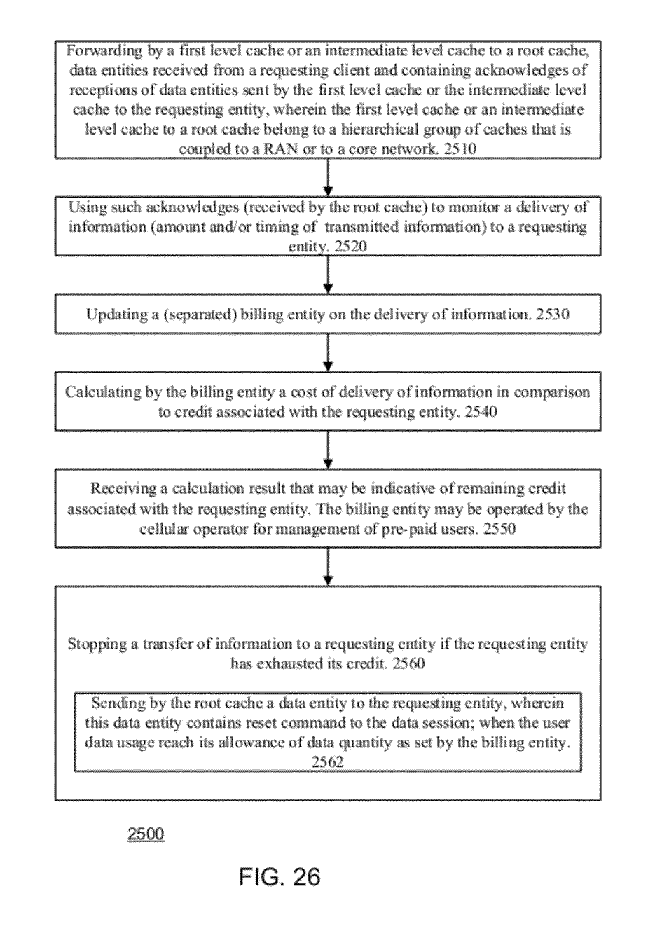

FIG. 26 illustrates method 2500 according to an embodiment of the invention.

Method 2500 may start by stage 2510 of forwarding by a first level cache or an intermediate level cache to a root cache, data entities received from a requesting client and containing acknowledges of receptions of data entities sent by the first level cache or the intermediate level cache to the requesting entity, wherein the first level cache or an intermediate level cache to a root cache belong to a hierarchical group of caches that is coupled to a RAN or to a core network.

Stage 2510 may be followed by stages 2520-2560.

Stage 2520 may include using such acknowledges (received by the root cache) to monitor a delivery of information (amount and/or timing of transmitted information) to a requesting entity.

Stage 2530 may include updating a (separated) billing entity on the delivery of information.

Stage 2540 may include calculating by the billing entity a cost of delivery of information in comparison to credit associated with the requesting entity.

Stage 2550 may include receiving a calculation result that may be indicative of remaining credit associated with the requesting entity. The billing entity may be operated by the cellular operator for management of pre-paid users.

Stage 2560 may include stopping a transfer of information to a requesting entity if the requesting entity has exhausted its credit.

Stage 2560 may include sending by the root cache a data entity to the requesting entity, wherein this data entity contains reset command to the data session; when the user data usage reach its allowance of data quantity as set by the billing entity.

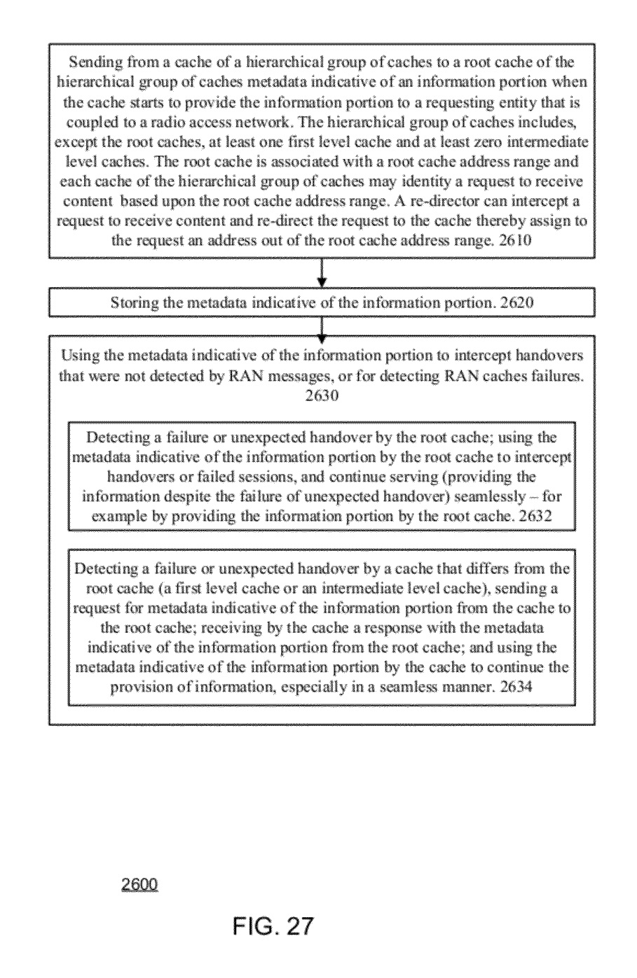

FIG. 27 illustrates method 2600 according to an embodiment of the invention.

Method 2600 may starts by stage 2610 of sending from a cache of a hierarchical group of caches to a root cache of the hierarchical group of caches metadata indicative of an information portion when the cache starts to provide the information portion to a requesting entity that is coupled to a radio access network. The hierarchical group of caches includes, except the root caches, at least one first level cache and at least zero intermediate level caches. The root cache is associated with a root cache address range and each cache of the hierarchical group of caches may identity a request to receive content based upon the root cache address range. A re-director can intercept a request to receive content and re-direct the request to the cache thereby assign to the request an address out of the root cache address range.

Stage 2610 may be followed by stage 2620 of storing the metadata indicative of the information portion.

Stage 2620 may be followed by stage 2630 of using the metadata indicative of the information portion to intercept handovers that were not detected by RAN messages, or for detecting RAN caches failures.

Stage 2630 may include stage 2632 of detecting a failure or unexpected handover by the root cache; using the metadata indicative of the information portion by the root cache to intercept handovers or failed sessions, and continue serving (providing the information despite the failure of unexpected handover) seamlessly—for example by providing the information portion by the root cache.

Stage 2630 may include stage 2634 of detecting a failure or unexpected handover by a cache that differs from the root cache (a first level cache or an intermediate level cache), sending a request for metadata indicative of the information portion from the cache to the root cache; receiving by the cache a response with the metadata indicative of the information portion from the root cache; and using the metadata indicative of the information portion by the cache to continue the provision of information, especially in a seamless manner.

According to an embodiment of the invention, any request for information from a requesting entity that is tagged as a requesting entity for which information exchange should be recorded may be serviced by the root cache and not by any other member of the hierarchical group of caches.

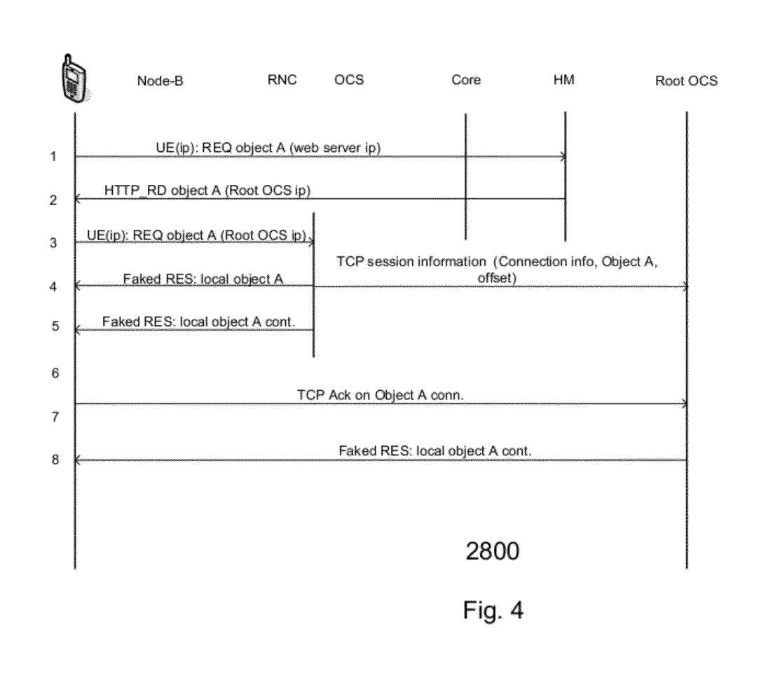

FIG. 4 illustrates a timing diagram 2800 that represents a detecting of a failure or unexpected handover by the root cache; using the metadata indicative of the information portion by the root cache to intercepts handovers or failed sessions and continue serving seamlessly.

Any of the methods mentioned above can be implemented by a computer that executes instructions stored in a non-transitory computer readable medium.

Because the illustrated embodiments of the present invention may for the most part, be implemented using electronic components and circuits known to those skilled in the art, details will not be explained in any greater extent than that considered necessary for the understanding and appreciation of the underlying concepts of the present invention and in order not to obfuscate or distract from the teachings of the present invention.

We claim:

1. A method comprising:
receiving, at a first level cache that is coupled to a radio access network (RAN) component, a data entity that comprises an address; wherein the first level cache belongs to a hierarchical group of caches that comprises a root cache, at least zero intermediate level caches and at least one first level cache; wherein each cache of the hierarchical group of caches is coupled to a component of the RAN or to a component of a core network that is coupled between the RAN and the Internet;
identifying the data entity as comprising a request to receive information from a requesting entity that is wirelessly coupled to the RAN—if the address belongs to a root cache address range;
providing the information, by the first level cache, to the requesting entity if the content is stored in the first level cache; and
sending to an intermediate level cache the data entity if the information is not stored in the first level cache.

2. The method according to claim 1, comprising:
receiving, by an intermediate level cache, the data entity;
providing the information, by the intermediate level cache, to the requesting entity if the information is stored in the intermediate level cache; and
sending to a higher level cache the data entity if the information is not stored in the intermediate level cache.

3. The method according to claim 1, wherein the identifying is being executed without performing deep packet probing.

4. The method according to claim 1, comprising:
intercepting handover information indicative of an expected handover of the requesting entity from a first site of the RAN to a second site of the RAN;
wherein the expected handover is expected to occur before an information portion is to be provided to the requesting entity;
wherein the first site is serviced by the first level cache and the second site is serviced by another cache of the hierarchical group of caches;
sending from the first level cache to other cache metadata indicative of the information portion; and
providing the information portion to the requesting entity by the other cache after an occurrence of the handover.

5. The method according to claim 4, comprising terminating by the first level cache a connection between the requesting entity and the first level cache in proximity to the handover.

6. The method according to claim 4, comprising determining to terminate a connection between the requesting entity and the first level cache in proximity to the handover in response to a size of the information portion; and terminating the connection in proximity to the handover if it is determined to terminate the connection.

7. The method according to claim 1, comprising receiving another request from the requesting entity to obtain additional information, while the first level cache provides previously requested information over a currently established connection between the requesting entity and the first level cache; and determining, by the first level cache, whether to provide the additional information over the previously established connection in response to at least one parameter out of (a) a size of the previously requested information, (b) a size of portion of the previously requested information that was not yet provided to the requesting entity; (c) a size of portion of the previously requested information that was already provided to the requesting entity; (d) a size of the additional information.

8. The method according to claim 1, comprising receiving another request from the requesting entity to obtain additional information, while the first level cache provides previously requested information over a currently established connection between the requesting entity and the first level cache; and determining, by the first level cache, whether to provide the additional information over the previously established connection in response to a size of the additional information and at least one size attribute related to the previously requested information.

9. The method according to claim 1, comprising receiving another request from the requesting entity to obtain additional information, while the first level cache provides previously requested information over a currently established connection between the requesting entity and the first level cache; and determining, by the first level cache, whether to provide the additional information over another connection in response to at least one out of a size of the additional information and at least one size attribute related to the previously requested information.

10. The method according to claim 1, comprising receiving another request from the requesting entity to obtain additional information, while the first level cache provides previously requested information over a currently established connection between the requesting entity and the first level cache; and determining, by the first level cache, whether to provide the additional information over another connection or over the previously established connection in response to a number of information requests that are serviced over the previously established connection.

11. The method according to claim 1, comprising receiving another request from the requesting entity to obtain additional information, while the first level cache provides previously requested information over a currently established connection between the requesting entity and the first level cache; and determining, by the first level cache, whether to provide the additional information by the first level cache or a higher level cache of the hierarchical group of caches in response to a characteristic of one or more information requests that are serviced by the first level cache.

12. The method according to claim 1, comprising:
intercepting handover information indicative of an expected handover of the requesting entity from a first site of the RAN to a second site of the RAN;
wherein the expected handover is expected to occur before an information portion is to be provided to the requesting entity;
wherein requests for information generated after the handover at the first site are serviced by the first level cache and requests for information generated after the handover at the second site is serviced by another cache of the hierarchical group of caches; and
providing the information portion to the first site by the first level cache to be later transmitted from the first site to the second site.

13. The method according to claim 1, wherein the root cache caches all information stored in any other caches of the hierarchical group of caches.

14. The method according to claim 1, comprising receiving, by the first level cache, quality of service information from the root cache; and providing the information, by the first level cache, to the requesting entity in response to the quality of service information.

15. The method according to claim 1, wherein the root cache is an out of band root cache.

16. The method according to claim 1, comprising: intercepting handover information indicative of a previously executed handover of the requesting entity from a first site of the RAN serviced by the first level cache to a second site of the RAN being serviced by another cache of the hierarchical group of caches; receiving from the other cache a request to provide metadata indicative of a state of a connection being currently utilized to provide information to the requesting entity; and terminating the connection.

17. The method according to claim 1, comprising: intercepting handover information indicative of a previously executed handover of the requesting entity from a first site of the RAN serviced by the first level cache to a second site of the RAN being serviced by another cache of the hierarchical group of caches; receiving from the other cache a request to provide metadata indicative of information yet to be provided to the requesting entity; and terminating the connection.

18. The method according to claim 1 comprising sending from the first level cache to the root cache metadata indicative of an information portion to be provided to the requesting entity by the first level cache; and using the metadata indicative of the information portion to intercept handovers that were not detected by RAN messages, or for detecting cache failures.

19. The method according to claim 19 comprising sending from the first level cache to the root cache metadata indicative of an information portion to be provided to the requesting entity by the first level cache; and using the metadata indicative of the information portion to intercept handovers from uncovered RAN segments to a RAN segment covered by the first level cache.

20. A method comprising:
intercepting, by a redirector, a request from a requesting entity that is coupled to a radio access network (RAN), to receive information from an information source that is coupled to the Internet or belongs to the Internet;
determining, by the redirector, whether the information should be provided from the information source or from a cache of a hierarchical group of caches that comprises a root cache, at least zero intermediate level caches and at least one first level cache;
if it is determined to provide the information from the cache then associating with the information an address out of a root cache address range, the address is indicative that the information is to be provided by a cache of the hierarchical group of caches.

21. The method according to claim 20, comprising:
receiving from the requesting entity a data entity that comprises a request to receive the information, the request comprises the address out of the root cache address range;
identifying the data entity as comprising the request to receive the information in response to the address; and
providing the information, by a cache of the hierarchical group of caches.

22. The method according to claim 20, comprising receiving by the root cache the data entity; and providing by the root cache the information.

23. The method according to claim 20, comprising pushing, by the root cache, information stored in the root cache to other caches of the hierarchical group of caches.

24. The method according to claim 23, comprising pushing, by the root cache, information stored in the root cache to other caches of the hierarchical group of caches;
wherein the pushing is responsive to a status of the RAN.

25. The method according to claim 20, comprising determining, the redirector, that the information should be provided from the information source and not from any cache of the hierarchical group of caches if the requesting entity is tagged as a requesting entity for which information exchange should be recorded.

26. The method according to claim 20, comprising determining, the redirector, that the information should be provided from the root cache if the requesting entity is tagged as a requesting entity for which information exchange should be recorded; wherein if it is determined that the information should be provided from the root cache than assigning to the information an address out of a dedicated address range allocated for information that is to be provided to requesting entities that are tagged as requesting entities for which information exchange should be recorded; wherein the dedicated address range differs from the root cache address range.

27. The method according to claim 26, wherein any request for information from a requesting entity that is tagged as a requesting entity for which information exchange should be recorded is serviced by the root cache and not by any other member of the hierarchical group of caches.

28. The method according to claim 20, comprising transmitting quality of information metadata to other caches of the hierarchical group of caches.

29. A non-transitory computer readable medium that is arranged to store instructions for:
receiving, at a first level cache that is coupled to a radio access network (RAN) component, a data entity that comprises an address; wherein the first level cache belongs to a hierarchical group of caches that comprises a root cache, at least zero intermediate level caches and at least one first level cache; wherein each cache of the hierarchical group of caches is coupled to a component of the RAN or to a component of a core network that is coupled between the RAN and the Internet;
identifying the data entity as that is arranged to store instructions for a request to receive information from a requesting entity that is wirelessly coupled to the RAN—if the address belongs to a root cache address range;
providing the information to the requesting entity if the content is stored in the first level cache; and
sending to an intermediate level cache the data entity if the information is not stored in the first level cache.

30. The non-transitory computer readable medium according to claim 29, that is arranged to store instructions for:
receiving, by an intermediate level cache, the data entity;
providing the information, by the intermediate level cache, to the requesting entity if the information is stored in the intermediate level cache; and
sending to a higher level cache the data entity if the information is not stored in the intermediate level cache.

31. The non-transitory computer readable medium according to claim 29, that is arranged to store instructions for identifying without performing deep packet probing.

32. The non-transitory computer readable medium according to claim 29, that is arranged to store instructions for:
intercepting handover information indicative of an expected handover of the requesting entity from a first site of the RAN to a second site of the RAN;
wherein the expected handover is expected to occur before an information portion is to be provided to the requesting entity;
wherein the first site is serviced by the first level cache and the second site is serviced by another cache of the hierarchical group of caches;
sending from the first level cache to other cache metadata indicative of the information portion; and
providing the information portion to the requesting entity by the other cache after an occurrence of the handover.

33. The non-transitory computer readable medium according to claim 32, that is arranged to store instructions for terminating by the first level cache a connection between the requesting entity and the first level cache in proximity to the handover.

34. The non-transitory computer readable medium according to claim 30, that is arranged to store instructions for determining to terminate a connection between the requesting entity and the first level cache in proximity to the handover in response to a size of the information portion; and terminating the connection in proximity to the handover if it is determined to terminate the connection.

35. The non-transitory computer readable medium according to claim 29, that is arranged to store instructions for receiving another request from the requesting entity to obtain additional information, while the first level cache provides previously requested information over a currently established connection between the requesting entity and the first level cache; and determining, by the first level cache, whether to provide the additional information over the previously established connection in response to at least one parameter out of (a) a size of the previously requested information, (b) a size of portion of the previously requested information that was not yet provided to the requesting entity; (c) a size of portion of the previously requested information that was already provided to the requesting entity; (d) a size of the additional information.

36. The non-transitory computer readable medium according to claim 29, that is arranged to store instructions for receiving another request from the requesting entity to obtain additional information, while the first level cache provides previously requested information over a currently established connection between the requesting entity and the first level cache; and determining, by the first level cache, whether to provide the additional information over the previously established connection in response to a size of the additional information and at least one size attribute related to the previously requested information.

37. The non-transitory computer readable medium according to claim 29, that is arranged to store instructions for receiving another request from the requesting entity to obtain additional information, while the first level cache provides previously requested information over a currently established connection between the requesting entity and the first level cache; and determining, by the first level cache, whether to provide the additional information over another connection in response to at least one out of a size of the additional information and at least one size attribute related to the previously requested information.

38. The non-transitory computer readable medium according to claim 29, that is arranged to store instructions for receiving another request from the requesting entity to obtain additional information, while the first level cache provides previously requested information over a currently established connection between the requesting entity and the first level cache; and determining, by the first level cache, whether to provide the additional information over another connection or over the previously established connection in response to a number of information requests that are serviced over the previously established connection.

39. The non-transitory computer readable medium according to claim 29, that is arranged to store instructions for receiving another request from the requesting entity to obtain additional information, while the first level cache provides previously requested information over a currently established connection between the requesting entity and the first level cache; and determining, by the first level cache, whether to provide the additional information by the first level cache or a higher level cache of the hierarchical group of caches in response to a characteristic of one or more information requests that are serviced by the first level cache.

40. The non-transitory computer readable medium according to claim 29, that is arranged to store instructions for:
intercepting handover information indicative of an expected handover of the requesting entity from a first site of the RAN to a second site of the RAN;
wherein the expected handover is expected to occur before an information portion is to be provided to the requesting entity;
wherein requests for information generated after the handover at the first site are serviced by the first level cache and requests for information generated after the handover at the second site is serviced by another cache of the hierarchical group of caches; and
providing the information portion to the first site by the first level cache to be later transmitted from the first site to the second site.

41. The non-transitory computer readable medium according to claim 29, that is arranged to store instructions for storing at the root cache caches all information stored in any other caches of the hierarchical group of caches.

42. The non-transitory computer readable medium according to claim 29, that is arranged to store instructions for receiving quality of service information from the root cache; and providing the information to the requesting entity in response to the quality of service information.

43. The non-transitory computer readable medium according to claim 29, that is arranged to store instructions for intercepting handover information indicative of a previously executed handover of the requesting entity from a first site of the RAN serviced by the first level cache to a second site of the RAN being serviced by another cache of the hierarchical group of caches; receiving from the other cache a request to provide metadata indicative of a state of a connection being currently utilized to provide information to the requesting entity; and terminating the connection.

44. The non-transitory computer readable medium according to claim 29, that is arranged to store instructions for intercepting handover information indicative of a previously executed handover of the requesting entity from a first site of the RAN serviced by the first level cache to a second site of the RAN being serviced by another cache of the hierarchical group of caches; receiving from the other cache a request to provide metadata indicative of information yet to be provided to the requesting entity; and terminating the connection.

45. The non-transitory computer readable medium according to claim 29, that is arranged to store instructions for sending metadata indicative of an information portion to be provided to the requesting entity by a first level cache; and using the metadata indicative of the information portion to intercept handovers that were not detected by RAN messages, or for detecting cache failures.

46. A non-transitory computer readable medium that is arranged to store instructions for:
intercepting a request from a requesting entity that is coupled to a radio access network (RAN), to receive information from an information source that is coupled to the Internet or belongs to the Internet;
determining whether the information should be provided from the information source or from a cache of a hierarchical group of caches that comprises a root cache, at least zero intermediate level caches and at least one first level cache;
if it is determined to provide the information from the cache then associating with the information an address out of a root cache address range, the address is indicative that the information is to be provided by a cache of the hierarchical group of caches.

47. The non-transitory computer readable medium according to claim 46, that is arranged to store instructions for:
receiving from the requesting entity a data entity that comprises a request to receive the information, the request comprises the address out of the root cache address range;
identifying the data entity as that is arranged to store instructions for the request to receive the information in response to the address; and
providing the information, by a cache of the hierarchical group of caches.

48. The non-transitory computer readable medium according to claim 46, that is arranged to store instructions for receiving by the root cache the data entity; and providing by the root cache the information.

49. The non-transitory computer readable medium according to claim 46, that is arranged to store instructions for pushing, by the root cache, information stored in the root cache to other caches of the hierarchical group of caches.

50. The non-transitory computer readable medium according to claim 49, that is arranged to store instructions for pushing, by the root cache, information stored in the root cache to other caches of the hierarchical group of caches; wherein the pushing is responsive to a status of the RAN.

51. The non-transitory computer readable medium according to claim 46, that is arranged to store instructions for determining, the redirector, that the information should be provided from the information source and not from any cache of the hierarchical group of caches if the requesting entity is tagged as a requesting entity for which information exchange should be recorded.

52. The non-transitory computer readable medium according to claim 46, that is arranged to store instructions for determining, the redirector, that the information should be provided from the root cache if the requesting entity is tagged as a requesting entity for which information exchange should be recorded; wherein if it is determined that the information should be provided from the root cache than assigning to the information an address out of a dedicated address range allocated for information that is to be provided to requesting entities that are tagged as requesting entities for which information exchange should be recorded; wherein the dedicated address range differs from the root cache address range.

53. The non-transitory computer readable medium according to claim 52, wherein any request for information from a requesting entity that is tagged as a requesting entity for which information exchange should be recorded is serviced by the root cache and not by any other member of the hierarchical group of caches.
